(19) United States
(12) Patent Application Publication
(10) Pub. No.: US 2025/0260540 A1
(43) Pub. Date: Aug. 14, 2025

(54) REFERENCE SIGNAL ASSOCIATION FOR MULTIPLE UPLINK CODEWORDS

(71) Applicant: QUALCOMM INCORPORATED, San Diego, CA (US)

(72) Inventors: Shaozhen Guo, Beijing (CN); Mostafa Khoshnevisan, San Diego, CA (US); Jing Sun, San Diego, CA (US); Xiaoxia Zhang, San Diego, CA (US)

(21) Appl. No.: 18/844,218

(22) PCT Filed: Apr. 29, 2022
(86) PCT No.: PCT/CN2022/090487

§ 371 Date: Sep. 5, 2024

(51) Int. Cl. H04L 5/00; H04W 72/231

(52) U.S. Cl. CPC H04L 5/0053; H04L 5/0044; H04L 5/0091; H04W 72/231

(57) ABSTRACT

Methods, systems, and devices for wireless communications are described. A user equipment (UE) may receive radio resource control signaling including an indication of a transmission mode for a physical uplink shared channel (PUSCH) and a phase tracking reference signal (PT-RS) configuration. The UE may receive downlink control information (DCI) including an indication of an association between PT-RS ports and demodulation reference signal (DM-RS) ports based on the PT-RS configuration. In some examples, the DCI schedules a first codeword and a second codeword for an uplink transmission. The UE may select a codeword from the first codeword and the second codeword for the uplink transmission, and may transmit, via the PUSCH according to the transmission mode, a PT-RS corresponding to a DM-RS port of a set of DM-RS ports associated with the selected codeword based on the association.

### CROSS REFERENCE

The present Application is a 371 national stage filing of International PCT Application No. PCT/CN2022/090487 by Guo et al. entitled “REFERENCE SIGNAL ASSOCIATION FOR MULTIPLE UPLINK CODEWORDS,” filed Apr. 29, 2022, which is assigned to the assignee hereof, and which is expressly incorporated by reference in its entirety herein.

### FIELD OF TECHNOLOGY

The present disclosure relates to wireless communications, including reference signal association for multiple uplink codewords.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device, such as a UE, may experience one or more types or sources of noise that may impact communications at the UE (e.g., from communications performed by the UE, from one or more other wireless devices such as another UE, a network entity, from one or more other sources, phase noise, thermal noise, or otherwise additive noise sources). Phase Tracking Reference Signals (PT-RSs) may be used to track the phase of a local oscillator at a transmitting device to reduce the effects of oscillator phase noise on communications. PT-RSs (e.g., PT-RS repetitions, occasions, instances) may be transmitted via one or more resources of a communications channel (e.g., physical uplink shared channel (PUSCH), physical downlink shared channel (PDSCH)). In some examples, the port used to transmit PT-RS occasions may be associated with one or more ports used to transmit other reference signals, for example, such as demodulation reference signals (DM-RSs) such that a PT-RS may be transmission over a set of resources (e.g., spatial resources, layers) associated with reliable communications (e.g., a strongest layer). The UE may transmit one or more PT-RS occasions in one or more resources of the communications channel according to the association.

### SUMMARY

The described techniques relate to improved methods, systems, devices, and apparatuses that support reference signal association for multiple uplink codewords. For example, the described techniques provide for transmitting phase tracking reference signals (PT-RSs) according to an association between one or more PT-RS ports and one or more demodulation reference signal (DM-RS) ports when an uplink channel is scheduled with two or more codewords and multiple spatial resources (e.g., layers).

For example, a number of antenna ports for transmitting DM-RSs may be configured via control information (e.g., downlink control information (DCI)) which may indicate which resources or ports, or both over which to transmit DM-RSs. The control information or other control signaling (e.g., DCI, radio resource control (RRC) signaling) may indicate an association between one or more configured PT-RS ports and the one or more DM-RS ports. In some examples, more than one DM-RS port may be associated with each configured PT-RS port.

A network entity may schedule an uplink channel (e.g., a physical uplink shared channel (PUSCH)) transmission at the UE having a number of spatial layers (e.g., up to four), each layer may be associated with a port for transmitting a DM-RS. When the uplink physical channel transmissions is scheduled with 2 to 4 layers, the UE may support two codewords for transmission of the uplink channel, each having an associated set of DM-RS ports. As such, the UE may determine one or more PT-RS/DM-RS associations when two codewords are scheduled for multi-layer uplink data transmission by selecting a codeword out of the scheduled codewords based on one or more parameters associated with the uplink data transmission, control signaling, control information, or a combination thereof. The UE may determine which DM-RS ports are associated with the selected codeword and may determine the PT-RS/DM-RS association based on a PT-RS/DM-RS association indication via uplink DCI. As such, the PT-RS/DM-RS association for transmitting PT-RSs over multi-codeword configurations may be based on the selected codeword.

A method for wireless communication at a user equipment (UE) is described. The method may include receiving radio resource control signaling including an indication of a transmission mode for a physical uplink shared channel and a phase tracking reference signal (PT-RS) configuration, receiving downlink control information including an indication of an association between PT-RS ports and demodulation reference signal (DM-RS) ports based on the PT-RS configuration, where the downlink control information schedules a first codeword and a second codeword for an uplink transmission, selecting a codeword from the first codeword and the second codeword for the uplink transmission, and transmitting, via the physical uplink shared channel according to the transmission mode, a PT-RS corresponding to a DM-RS port of a set of DM-RS ports associated with the selected codeword based on the association.

An apparatus for wireless communication at a UE is described. The apparatus may include a processor, memory coupled with the processor, and instructions stored in the memory. The instructions may be executable by the processor to cause the apparatus to receive radio resource control signaling including an indication of a transmission mode for a physical uplink shared channel and a phase tracking reference signal (PT-RS) configuration, receive downlink control information including an indication of an association between PT-RS ports and demodulation reference signal (DM-RS) ports based on the PT-RS configuration, where the downlink control information schedules a first codeword and a second codeword for an uplink transmission, select a codeword from the first codeword and the second codeword for the uplink transmission, and transmit, via the physical uplink shared channel according to the transmission mode, a PT-RS corresponding to a DM-RS port of a set of DM-RS ports associated with the selected codeword based on the association.

Another apparatus for wireless communication at a UE is described. The apparatus may include means for receiving radio resource control signaling including an indication of a transmission mode for a physical uplink shared channel and a phase tracking reference signal (PT-RS) configuration, means for receiving downlink control information including an indication of an association between PT-RS ports and demodulation reference signal (DM-RS) ports based on the PT-RS configuration, where the downlink control information schedules a first codeword and a second codeword for an uplink transmission, means for selecting a codeword from the first codeword and the second codeword for the uplink transmission, and means for transmitting, via the physical uplink shared channel according to the transmission mode, a PT-RS corresponding to a DM-RS port of a set of DM-RS ports associated with the selected codeword based on the association.

A non-transitory computer-readable medium storing code for wireless communication at a UE is described. The code may include instructions executable by a processor to receive radio resource control signaling including an indication of a transmission mode for a physical uplink shared channel and a phase tracking reference signal (PT-RS) configuration, receive downlink control information including an indication of an association between PT-RS ports and demodulation reference signal (DM-RS) ports based on the PT-RS configuration, where the downlink control information schedules a first codeword and a second codeword for an uplink transmission, select a codeword from the first codeword and the second codeword for the uplink transmission, and transmit, via the physical uplink shared channel according to the transmission mode, a PT-RS corresponding to a DM-RS port of a set of DM-RS ports associated with the selected codeword based on the association.

In some examples of the method, apparatuses, and non-transitory computer-readable medium described herein, selecting the codeword may include operations, features, means, or instructions for selecting the first codeword associated with a first modulation and coding scheme value, where the second codeword may be associated with a second modulation and coding scheme value that may be less than the first modulation and coding scheme value.

Some examples of the method, apparatuses, and non-transitory computer-readable medium described herein may further include operations, features, means, or instructions for determining that the first codeword associated with the first modulation and coding scheme value may be associated with at least two sounding reference signal (SRS) resource sets, at least two precoders, or both based on the PT-RS configuration indicating at least two available ports for transmitting one or more PT-RSs, where the physical uplink shared channel may be associated with a first set of transmission parameters and a second set of transmission parameters.

Some examples of the method, apparatuses, and non-transitory computer-readable medium described herein may further include operations, features, means, or instructions for transmitting a second PT-RS corresponding to a second DM-RS port of a second set of DM-RS ports associated with the selected codeword based on the association.

In some examples of the method, apparatuses, and non-transitory computer-readable medium described herein, selecting the codeword may include operations, features, means, or instructions for selecting the first codeword based on the first codeword being associated with at least two SRS resource sets, at least two precoders, or both.

Some examples of the method, apparatuses, and non-transitory computer-readable medium described herein may further include operations, features, means, or instructions for determining that a second codeword may be associated with at least two SRS resource sets, at least two precoders, or both, where selecting the first codeword may be further based on a modulation and coding scheme value of the first codeword, an index of the first codeword, or both.

In some examples of the method, apparatuses, and non-transitory computer-readable medium described herein, selecting the codeword may include operations, features, means, or instructions for selecting the first codeword associated with a first index and a first modulation and coding scheme value, where the second codeword may be associated with a second index that may be greater than the first index and a second modulation and coding scheme value that may be equal to the first modulation and coding scheme value.

In some examples of the method, apparatuses, and non-transitory computer-readable medium described herein, the radio resource control signaling, or the downlink control information, or both includes an indication of the first codeword or the second codeword, selecting the codeword includes, and selecting the indicated codeword.

In some examples of the method, apparatuses, and non-transitory computer-readable medium described herein, the PT-RS configuration indicates a single available port for transmitting a PT-RS and the transmission mode may be codebook-based or non-codebook-based.

In some examples of the method, apparatuses, and non-transitory computer-readable medium described herein, the indication of the association includes two bits indicating a DM-RS port of the set of DM-RS ports associated with the selected codeword.

In some examples of the method, apparatuses, and non-transitory computer-readable medium described herein, the PT-RS configuration indicates a set of multiple available ports for transmitting one or more PT-RSs.

In some examples of the method, apparatuses, and non-transitory computer-readable medium described herein, the indication of the association includes at least two bits and the method, apparatuses, and non-transitory computer-readable medium may include further operations, features, means, or instructions for transmitting a second PT-RS corresponding to the second DM-RS port of the second set of DM-RS ports associated with the selected codeword based on the association.

In some examples of the method, apparatuses, and non-transitory computer-readable medium described herein, a rank of the physical uplink shared channel may be less than or equal to a threshold rank.

In some examples of the method, apparatuses, and non-transitory computer-readable medium described herein, the set of DM-RS ports may be associated with a first SRS resource set, a first precoder, or both and the second set of DM-RS ports may be associated with a second SRS resource set, a second precoder, or both.

In some examples of the method, apparatuses, and non-transitory computer-readable medium described herein, the indication of the association includes a set of multiple bits and the method, apparatuses, and non-transitory computer-readable medium may include further operations, features, means, or instructions for transmitting a second PT-RS corresponding to the second DM-RS port of the second set of DM-RS ports associated with the selected codeword based on the association.

In some examples of the method, apparatuses, and non-transitory computer-readable medium described herein, a rank of the physical uplink shared channel may be greater than a threshold rank.

In some examples of the method, apparatuses, and non-transitory computer-readable medium described herein, the set of DM-RS ports may be associated with a first port for transmitting the PT-RS and a second set of ports may be associated with a second port for transmitting a second PT-RS.

In some examples of the method, apparatuses, and non-transitory computer-readable medium described herein, the transmission mode may be non-codebook-based.

In some examples of the method, apparatuses, and non-transitory computer-readable medium described herein, the downlink control information further includes an SRS resource indicator that indicates a set of multiple SRS resources and the method, apparatuses, and non-transitory computer-readable medium may include further operations, features, means, or instructions for determining which of the set of multiple available ports to use for transmitting the one or more PT-RSs based on the selected codeword and the SRS resource indicator, where each SRS resource may be associated with one of the set of multiple available ports for transmitting one or more PT-RSs.

In some examples of the method, apparatuses, and non-transitory computer-readable medium described herein, determining which of the set of multiple available ports to use for transmitting the one or more PT-RSs may include operations, features, means, or instructions for determining to use one of the set of multiple available ports based on an PT-RS port index associated with each SRS resource of the SRS resources associated with the selected codeword being the same and determining to use two or more of the set of multiple available ports based on an PT-RS port index associated with multiple SRS resource associated with the selected codeword being different.

In some examples of the method, apparatuses, and non-transitory computer-readable medium described herein, the transmission mode may be codebook-based.

In some examples of the method, apparatuses, and non-transitory computer-readable medium described herein, the downlink control information further includes a transmit precoding matrix index and the method, apparatuses, and non-transitory computer-readable medium may include further operations, features, means, or instructions for determining which of the set of multiple available ports to use for transmitting the one or more PT-RSs based on the selected codeword and the transmit precoding matrix index, where the transmit precoding matrix index indicates a set of antenna ports for transmitting the physical uplink shared channel and a precoding matrix including an association between the set of DM-RS ports and the set of antenna ports.

In some examples of the method, apparatuses, and non-transitory computer-readable medium described herein, determining which of the set of multiple available ports to use for transmitting the one or more PT-RSs may include operations, features, means, or instructions for determining to use one or more of the set of multiple available ports based on the association between the set of DM-RS ports and the set of antenna ports.

In some examples of the method, apparatuses, and non-transitory computer-readable medium described herein, the physical uplink shared channel may be associated with a first set of transmission parameters and a second set of transmission parameters.

A method for wireless communication is described. The method may include transmitting radio resource control signaling including an indication of a transmission mode for a physical uplink shared channel and a phase tracking reference signal (PT-RS) configuration, transmitting downlink control information including an indication of an association between PT-RS ports and demodulation reference signal (DM-RS) ports based on the PT-RS configuration, where the downlink control information schedules a first codeword and a second codeword for an uplink transmission, and receiving, via the physical uplink shared channel according to the transmission mode, a PT-RS corresponding to a DM-RS port of a set of DM-RS ports associated with a selected codeword based on the association.

An apparatus for wireless communication is described. The apparatus may include a processor, memory coupled with the processor, and instructions stored in the memory. The instructions may be executable by the processor to cause the apparatus to transmit radio resource control signaling including an indication of a transmission mode for a physical uplink shared channel and a phase tracking reference signal (PT-RS) configuration, transmit downlink control information including an indication of an association between PT-RS ports and demodulation reference signal (DM-RS) ports based on the PT-RS configuration, where the downlink control information schedules a first codeword and a second codeword for an uplink transmission, and receive, via the physical uplink shared channel according to the transmission mode, a PT-RS corresponding to a DM-RS port of a set of DM-RS ports associated with a selected codeword based on the association.

Another apparatus for wireless communication is described. The apparatus may include means for transmitting radio resource control signaling including an indication of a transmission mode for a physical uplink shared channel and a phase tracking reference signal (PT-RS) configuration, means for transmitting downlink control information including an indication of an association between PT-RS ports and demodulation reference signal (DM-RS) ports based on the PT-RS configuration, where the downlink control information schedules a first codeword and a second codeword for an uplink transmission, and means for receiving, via the physical uplink shared channel according to the transmission mode, a PT-RS corresponding to a DM-RS port of a set of DM-RS ports associated with a selected codeword based on the association.

A non-transitory computer-readable medium storing code for wireless communication is described. The code may include instructions executable by a processor to transmit radio resource control signaling including an indication of a transmission mode for a physical uplink shared channel and a phase tracking reference signal (PT-RS) configuration, transmit downlink control information including an indication of an association between PT-RS ports and demodulation reference signal (DM-RS) ports based on the PT-RS configuration, where the downlink control information schedules a first codeword and a second codeword for an uplink transmission, and receive, via the physical uplink shared channel according to the transmission mode, a PT-RS corresponding to a DM-RS port of a set of DM-RS ports associated with a selected codeword based on the association.

Some examples of the method, apparatuses, and non-transitory computer-readable medium described herein may further include operations, features, means, or instructions for receiving a second PT-RS corresponding to a second DM-RS port of the set of DM-RS ports associated with the selected codeword based on the association.

In some examples of the method, apparatuses, and non-transitory computer-readable medium described herein, the indication of the association includes at least two bits indicating the DM-RS port of the set of DM-RS ports associated with the selected codeword.

### BRIEF DESCRIPTION OF THE DRAWINGS

FIG. 1 illustrates an example of a wireless communications system that supports reference signal association for multiple uplink codewords in accordance with one or more aspects of the present disclosure.

FIG. 2 illustrates an example of a wireless communications system that supports reference signal association for multiple uplink codewords in accordance with one or more aspects of the present disclosure.

FIG. 3 illustrates an example of a wireless communications that supports reference signal association for multiple uplink codewords in accordance with one or more aspects of the present disclosure.

FIGS. 4A, 4B, & 4C each illustrate an example of a spatial multiplexing configuration that supports reference signal association for multiple uplink codewords in accordance with one or more aspects of the present disclosure.

FIGS. 5A & 5B illustrate examples of wireless communications systems that each support reference signal association for multiple uplink codewords in accordance with one or more aspects of the present disclosure.

FIG. 6 illustrates an example of a process flow that supports reference signal association for multiple uplink codewords in accordance with one or more aspects of the present disclosure.

FIGS. 7 and 8 show block diagrams of devices that support reference signal association for multiple uplink codewords in accordance with one or more aspects of the present disclosure.

FIG. 9 shows a block diagram of a communications manager that supports reference signal association for multiple uplink codewords in accordance with one or more aspects of the present disclosure.

FIG. 10 shows a diagram of a system including a device that supports reference signal association for multiple uplink codewords in accordance with one or more aspects of the present disclosure.

FIGS. 11 and 12 show block diagrams of devices that support reference signal association for multiple uplink codewords in accordance with one or more aspects of the present disclosure.

FIG. 13 shows a block diagram of a communications manager that supports reference signal association for multiple uplink codewords in accordance with one or more aspects of the present disclosure.

FIG. 14 shows a diagram of a system including a device that supports reference signal association for multiple uplink codewords in accordance with one or more aspects of the present disclosure.

FIGS. 15 through 20 show flowcharts illustrating methods that support reference signal association for multiple uplink codewords in accordance with one or more aspects of the present disclosure.

### DETAILED DESCRIPTION

Some wireless communications systems may support communications in relatively higher frequency bands (e.g., FR2, FR4). Communications in these frequencies may be associated with higher levels of some types of noise, for example, such as phase noise. A wireless device, such as a user equipment UE may experience phase noise which may impact communications at the UE (e.g., from communications performed by the UE, from one or more other wireless devices such as another UE, a network entity, from one or more other sources). Phase Tracking Reference Signals (PT-RSs) may be used to track the phase of a local oscillator at a UE to reduce the effects of oscillator phase noise on communications.

For example, a UE may transmit one or more PT-RSs via one or more resources of a physical channel (e.g., physical uplink shared channel (PUSCH)). In some examples, the antenna port used for transmission of PT-RSs may be associated with one or more antenna ports used for transmission of other reference signals, for example, such as demodulation reference signals (DM-RS). The UE may transmit one or more PT-RSs via one or more resources of the physical uplink channel according to the association.

A number of antenna ports for transmitting DM-RS may be configured via control signaling (e.g., physical downlink control channel (PDCCH) signaling including downlink control information (DCI)). This control signaling or other control signaling (e.g., RRC signaling) may indicate an association between the one or more PT-RS ports and the one or more DM-RS ports based on a single codeword associated with the physical uplink channel. In some examples, more than one DM-RS port may be associated with each configured PT-RS port. A network entity may schedule an uplink transmission (e.g., PUSCH) for the UE having a number of spatial layers, each layer associated with a port for transmitting a DM-RS. When the uplink transmission is scheduled with 2 to 4 or more layers, the UE may support multiple codewords for transmission of the uplink physical channel, each having an associated set of DM-RS ports. Thus, the UE may determine a PT-RS/DM-RS association corresponding to one of the multiple codewords.

For example, the UE may determine PT-RS/DM-RS associations when multiple codewords are scheduled for multi-layer PUSCH by selecting a codeword out of the total number of scheduled codewords based on one or more parameters associated with the uplink transmission or based on control signaling or control information. The UE may determine which DM-RS ports are associated with the selected codeword and may determine the PT-RS/DM-RS association based on a PT-RS/DM-RS association indication received via uplink DCI from a network entity. As such, the PT-RS/DM-RS association for multi-codeword configurations may be based on the selected codeword of the number of scheduled codewords.

Aspects of the disclosure are initially described in the context of wireless communications systems. Aspects of the disclosure are further described in the context of spatial multiplexing configurations as well as a process flow. Aspects of the disclosure are further illustrated by and described with reference to apparatus diagrams, system diagrams, and flowcharts that relate to reference signal association for multiple uplink codewords.

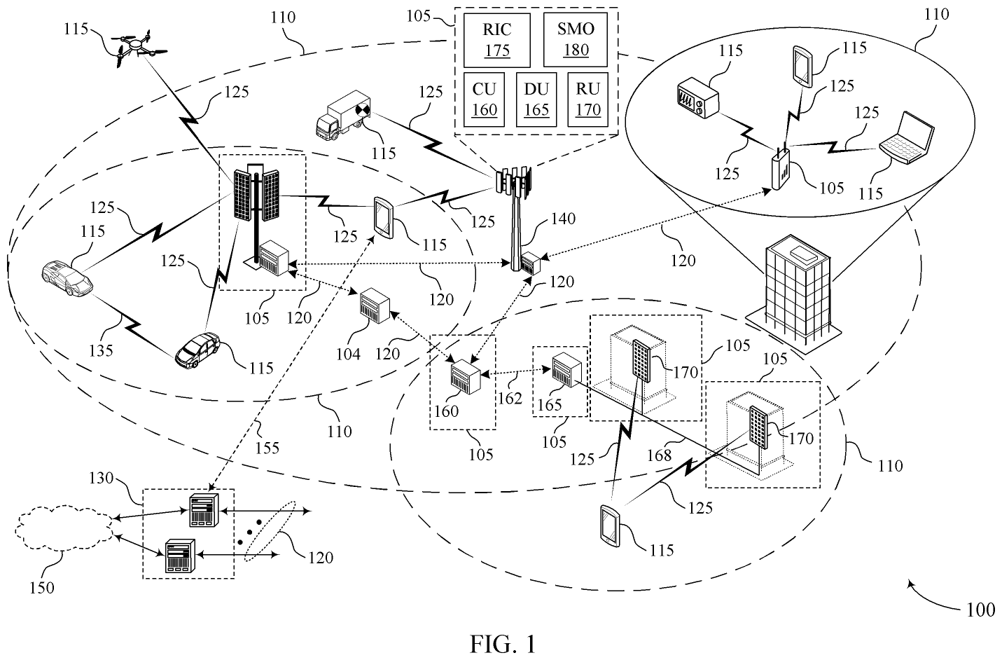

FIG. 1 illustrates an example of a wireless communications system 100 that supports reference signal association for multiple uplink codewords in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support reference signal association for multiple uplink codewords as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The UEs 115 may be configured for uplink data transmission via PUSCH. For example, a UE 115 may receive DCI scheduling resources for PUSCH including a number of resources allocated to reference signals including DM-RS. Additionally, the UE 115 may be configured with one or more sets of sounding reference signal resources via RRC signaling. In some examples, the wireless communications system 100 may support more than one mode of PUSCH transmission. For example, the wireless communications system 100 may support codebook-based PUSCH transmission or non-codebook-based PUSCH transmission, or both. For example, a UE 115 configured for codebook-based transmissions may be configured or scheduled with a single SRS resource set with a usage indicator set to “codebook.” In some examples, the UE 115 may receive a configuration for up to 4 SRS resources within the set. Each SRS resource may be RRC-configured with a number of ports (e.g., SRS ports, nrofSRS-Ports). In some examples, the UE 115 may receive, via uplink DCI, an SRS resource indicator (SRI) that indicates a single SRS resource of the set. The UE 115 may transmit the PUSCH with a same spatial domain filter (e.g., uplink transmission beam) as the indicated SRS resources. The number of layers (e.g., rank) and a transmitted precoding matrix indicator (TPMI) (e.g., precoder) for the scheduled PUSCH may be indicated by a DCI field associated with precoding information (e.g., a “precoding information and number of layers” field).

A UE 115 configured for non-codebook-based transmissions may be configured with a single SRS resource set with an associated SRS usage indicator set to “non-codebook.” The UE 115 may receive a configuration for up to 4 SRS resources within the set. Each SRS resource may be RRC-configured with a single port (e.g., SRS ports, nrofSRS-Ports). The SRI field in the uplink DCI (e.g., scheduling the PUSCH) may indicate one or more SRS resources of the set, where the number of indicated SRS resources may determine a rank (e.g., number of layers) for the scheduled PUSCH. In some examples, the UE 115 may transmit the PUSCH with a same spatial domain filter (e.g., uplink transmission beam) as well as a same precoder as the indicated SRS resources.

In some examples, a PT-RS for phase noise correction may be transmitted within a number of allocated resources blocks via one or more resource elements of the scheduled PUSCH. Phase noise may be especially prevalent in some frequency ranges and thus the use of PT-RS may particularly improve communications in those ranges. PT-RS may be transmitted via PUSCH OFDM symbols that are not allocated for DM-RS. In some examples, a DM-RS may obviate the use of PT-RS and thus resource blocks allocated for DM-RS may not additionally include PT-RS. In some examples, PT-RS may be transmitted relatively infrequently in the frequency domain (e.g., one time per port per 2 to 4 resource blocks) and may be transmitted relatively frequently in the time domain (e.g., per 1/2/4 OFDM symbols).

The UE 115 may receive RRC signaling including an RRC parameter (e.g., “PTRS-UplinkConfig”) configuring the occurrence of PT-RSs in the frequency and time domains. PT-RS may be transmitted via a number of ports (e.g., PT-RS ports indicated or configured by via RRC signaling (e.g., “maxNrofPorts”). In some examples, the number of ports may be one or two. For example, two PT-RS ports may be configured for CP-OFDM waveforms and one port may be configured for some types of UEs 115 (e.g., full-coherent UEs 115).

For non-codebook-based uplink communications, an actual number of PT-RS ports used for transmitting PT-RS out of the number of indicated ports (e.g., max number of ports) may be indicated by SRI. The SRI may indicate one or more SRS resources where each SRS resource may be configured with a PT-RS port index. If the indicated SRS resources (e.g., indicated by the SRI) have a same PT-RS port index, then the actual number of PT-RS ports may be one PT-RS port; Otherwise, the actual number of PT-RS ports may be two PT-RS ports.

For codebook-based uplink communications, if the UE is a partial-coherent or non-coherent UE, the actual number of PT-RS ports used for transmitting PT-RS out of the number of indicated ports (e.g., max number of ports) is determined based on TMPI (e.g., via the “Precoding information and number of layers” field).

In some examples (e.g., when PUSCH is scheduled with more than one spatial layer), a PT-RS port may be associated with a DM-RS port such that PT-RSs may be transmitted on a strongest layer (e.g., most reliable, least subject to noise, or otherwise most suitable) associated with the DM-RS port as determined by transmitting one or more DM-RSs. Some uplink DCI formats (e.g., formats 0_1; 0_2) may include a PT-RS/DM-RS association indication (e.g., field). In some examples, the PT-RS/DM-RS association indication may include two bits based on the following conditions being met: when the scheduled PUSCH is configured to include PT-RS, CP-OFDM is used (e.g., transform precoder is disabled), and a maximum rank of the scheduled PUSCH is greater than one, or any combination thereof. Otherwise, the DCI may be transmitted without an association indication.

In some examples, the control signaling may configure a single PT-RS port (e.g., PT-RS port 0). In such examples, the value of the association indication may indicate with which DM-RS port the single PT-RS port is associated. For example, a first value may indicate a first scheduled DM-RS port, a second value may indicate a second scheduled DM-RS port, and so on.

In some examples, the control signaling may configure two or more PT-RS ports (e.g., PT-RS port 0 and PT-RS port 1). In such examples, a first bit of the association indication may indicate which DM-RS port (e.g., out of the DM-RS ports that share or may be associated with the first PT-RS port) is associated with the first PT-RS port and a second bit of the association indication may indicate which DM-RS port (e.g., out of the DM-RS ports that share or may be associated with the second PT-RS port) is associated with the second PT-RS port.

In some examples, the DM-RS ports that share a PT-RS port may be determined according to a PUSCH transmission mode (e.g., codebook-based or non-codebook-based). For example, for non-codebook-based PUSCH, an SRI field may indicate one or multiple SRS resources. For example, there may be a one-to-one mapping between indicated SRS resources and indicated DM-RS ports (e.g., indicated by antenna ports field). Each SRS resource may be configured with a PT-RS port index.

As an example, SRS resources 0, 1 may be RRC-configured with PT-RS port 0 and SRS resources 2, 3 may be RRC configured with PT-RS port 1. In this example, the SRI may indicate 4 SRS resources, an “antenna ports” field may indicate DM-RS ports 0 through 3 where DM-RS ports 0 and 1 share PT-RS port 0 and DM-RS ports 2- and 3 share PT-RS port 1 as indicated by the PT-RS/DM-RS association indication.

For codebook-based PUSCH, in the case of some types of UEs 115 (e.g., coherent, non-coherent), the TPMI may indicate which DM-RS ports share a PTRS port based on one or more conditions or rules. For example, TPMI may indicate a first PUSCH antenna port 1000 and a third PUSCH antenna port 1002 share PT-RS port 0, and a second PUSCH antenna port 1001 and a fourth PUSCH antenna 1003 share PT-RS port 1. In such examples, DM-RS ports corresponding to the layers which are transmitted with PUSCH antenna port 1000 and PUSCH antenna port 1002 as indicated by the TPMI share PTRS port 0 and the DM-RS ports corresponding to the layers which are transmitted with PUSCH antenna port 1001 and PUSCH antenna port 1003 as indicated by the TPMI share PTRS port 1.

As an example, the precoding information and number of layers field in the DCI may indicate three layers and a TPMI index. The “Antenna ports” field may indicate that DM-RS ports 0-2 correspond to the three layers where the first layer is transmitted with PUSCH antenna ports 1000 and 1002 and DM-RS port 0 shares PTRS port 0, the second layer is transmitted with PUSCH antenna port 1001, and the third layer is transmitted with PUSCH antenna port 1003 where DM-RS port 1 and 2 share PTRS port 1. Note that in this example, the first bit of PTRS/DM-RS association indication may be irrelevant useless because a single DM-RS port “shares” PTRS port 0, but the second bit selects which DM-RS port (e.g., out DM-RS ports 1 and 2 that share PTRS port 1) is associated with PTRS port 1.

In some wireless communication systems, a single DCI may schedule a first set of PUSCH repetitions or layers and a second set of PUSCH repetitions or layers for transmission to at least two transmission/reception points (TRPs), which may be an example of a network entity 105. In some examples, each set may be associated with a beam configuration, power control parameters, or other transmission parameters and may be transmitted according to a time division duplexing configuration. In such examples, each set may correspond to a respective SRS resource set. For example, DCI may indicate two beams or two sets of power control parameters via corresponding SRI fields for both codebook-based and non-codebook-based PUSCH.

The DCI, in some examples, may include an indication field for dynamic switching between single TRP (sTRP) configurations and multi-TRP (mTRP) configurations (e.g., one set versus two sets of transmission parameters for PUSCH repetitions or layers). The indication may include two bits and may indicate one of: {use first set of parameters only (TRP1); use second set of parameters only (TRP2); use both sets of parameters for two sets of repetitions with a first order (TRP1,TRP2); use both sets of parameters for two sets of repetitions with a second order (TRP2,TRP1)} mapped to {00,01,10,11}.

Some DCI configurations may include an indication for dynamic switching between sTRP communications and mTRP communications. In some examples, the dynamic switching indication may include 2 bits according to Table 1, below.

TABLE 1
DCI for Dynamic Switching

| | | SRI (for codebook-based and non- |
|---|---|---|
| | | codebook based PUSCH)/TPMI (for |
| Codepoint | SRS resource set(s) | codebook) field(s) |
| 00 | sTRP with 1st SRS resource set (TRP1) | 1st SRI/TPMI field (2nd field is unused) |
| 01 | sTRP with 2nd SRS resource set (TRP2) | 1st SRI/TPMI field (2nd field is unused) |
| 10 | mTRP with (TRP1, TRP2) | Both 1st and 2nd SRI/TPMI fields |
| | 1st SRI/TPMI field: 1st SRS resource set | |
| | 2nd SRI/TPMI field: 2nd SRS resource set | |
| 11 | mTRP with (TRP2, TRP1) | Both 1st and 2nd SRI/TPMI fields |
| | 1st SRI/TPMI field: 1st SRS resource set | |
| | 2nd SRI/TPMI field: 2nd SRS resource set | |

In some examples, the SRS resource set with a lower ID index may be a first SRS resource set, and the remaining SRS resource set may be a second SRS resource set for both codebook-based and non-codebook-based usage.

For codepoint “11,” as shown in Table 1, the first repetition in time may be associated with the second SRS resource set, and the remaining repetitions may follow a configured mapping pattern (e.g., cyclic or sequential mapping pattern). For codepoint “10,” the first repetition in time may be associated with a first SRS resource set, and the remaining repetitions may follow the configured mapping pattern (cyclic or sequential).

In some example PUSCH configurations, a total number of spatial layers may be four or more and a total number of supported codewords may be up to two across the panels of a transmitting device (e.g., a UE 115).

In some examples, a PUSCH transmission may be scheduled for transmission over a number of spatial layers (e.g., two to four spatial layers) according to a spatial division multiplexing scheme (SDM) where different spatial layers are associated with a corresponding set of transmission parameters (e.g., beam configurations, power control parameters, TPMI values). In some such examples, the PUSCH transmission may include two codewords. As such, mechanisms for determining a PT-RS/DM-RS association when two codewords are scheduled for multi-layer PUSCH (e.g., sTRP PUSCH configurations or PUSCH configurations having a single set of transmission parameters) or SDM PUSCH with different set of transmission parameters (e.g., mTRP SDM PUSCH) may differ from mechanisms for determining PT-RS/DM-RS when a single codeword is scheduled.

For example, a UE 115 may receive RRC signaling including an indication of a transmission mode (e.g., codebook-based, non-codebook-based) for a PUSCH and a PT-RS configuration (e.g., nrofSRS-Ports). The UE 115 may receive DCI, for example, form a network entity, including an indication of an association between PT-RS ports and DM-RS ports based on the PT-RS configuration. That is, an indication of an association between PT-RS ports and DM-RS ports may be based on a number of PT-RS ports indicated by the PT-RS port configuration. In some examples, the DCI may schedule a first codeword and a second codeword for transmitting the PUSCH over one or more spatial layers. The UE 115 may select a codeword from the first codeword and the second codeword for the uplink transmission, and may transmit, via the PUSCH and according to the transmission mode, a PT-RS corresponding to a DM-RS port of a set of DM-RS ports associated with the selected codeword based on the association.

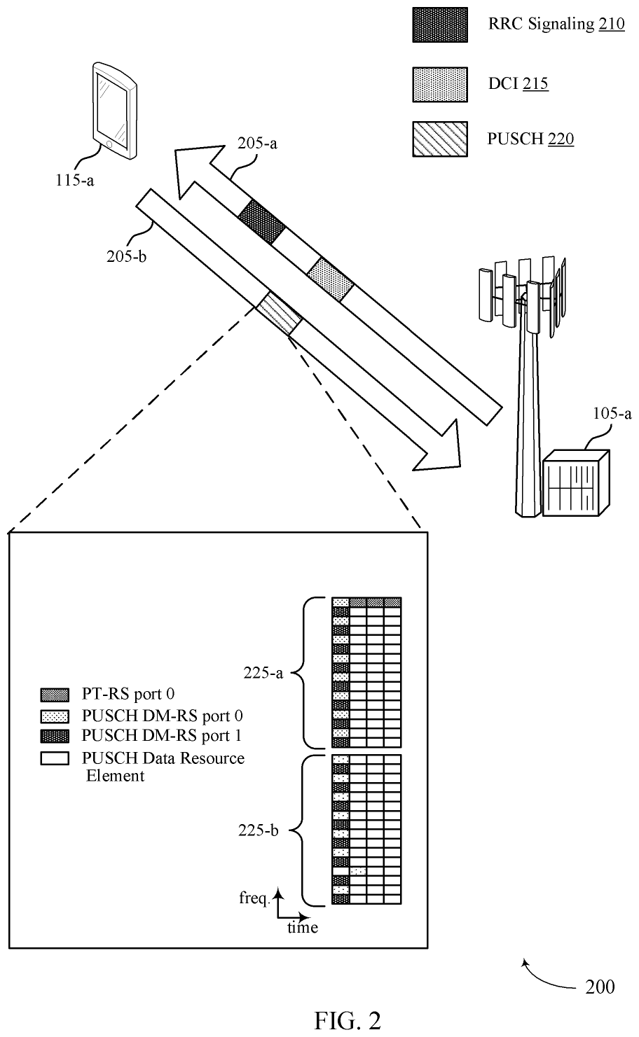

FIG. 2 illustrates an example of a wireless communications system 200 that supports reference signal association for multiple uplink codewords in accordance with one or more aspects of the present disclosure. In some examples, wireless communications system 200 may implement aspects of wireless communications system 100. The wireless communications system 200 may include a UE 115-a and a network entity 105-a, each of which may be examples of the corresponding devices as described with reference to FIG. 1. In some examples, the wireless communications system 200 may support sTRP configurations or PUSCH configurations associated with a single set of transmission parameters.

The wireless communications system 200 may support communications in relatively higher frequency bands (e.g., FR2, FR2x, FR4). In some examples, noise (e.g., phase noise) at these operating frequencies may be associated with higher levels than at other operating frequencies. To mitigate the effects of phase noise, the UE 115-a may transmit one or more PT-RSs via an uplink 205-b to track the phase of a local oscillator to reduce the effects of oscillator phase noise on communications between the UE 115-a and the network entity 105-a.

For example, the network entity 105-b may transmit RRC signaling 210 to the UE 115-a via downlink 205-a. In some examples, the RRC signaling 210 may configure a set of SRS resources as well as a number of ports associated with each SRS resource. In some examples, the UE 115-a may receive DCI 215 (e.g., scheduling PUSCH 220 for the UE 115-a) including an SRS resource indicator (SRI) that indicates one or more SRS resources of the set depending on the PUSCH transmission mode (e.g., codebook-based or non-codebook-based).

To transmit the one or more PT-RSs, the UE 115-a may determine an association between one or more ports used for other reference signals (e.g., DM-RS) and may transmit the one or more PT-RSs via one or more resource blocks 225 of a PUSCH 220 according to the association.

For example, for spatial division multiplexed PUSCH with a single set of transmission parameters, when the UE 115-a is scheduled with two or more codewords, the DM-RS ports from one of the codewords may be used for the PT-RS/DM-RS association. The UE 115-a may determine which codeword based on an MCS value of the scheduled codewords, an index of the scheduled codeword, an RRC configuration, or based on a DCI indication. For example, the UE 115-a may select the codeword with the higher MCS value or if the MCS values of the two scheduled codewords are the same, the UE 115-a may select the codeword with the smaller codeword index (e.g., codeword 0). In some examples, the UE 115-a may receive RRC signaling 210 or DCI 215 including an indication of the codeword to select.

The UE 115-a may determine PT-RS port(s) is associated with which DM-RS ports of the selected codeword based on the PT-RS/DM-RS association indication and the number of ports configured by the PTRS configuration. In some examples, the DCI 215 may include a PT-RS/DM-RS association indication based on the number of PT-RS ports configured by maxNrofPorts in “PTRS-UplinkConfig”. When one PT-RS port is configured, the PT-RS/DM-RS association indication may include two bits and the value of the field (e.g., 0, 1, 2, 3) may indicate with which DM-RS port of the selected codeword that the PT-RS port is associated, as shown in Table 2, below.

TABLE 2
PT-RS/DM-RS association for UL PT-RS port 0

| Value | DM-RS port of the selected CW |
|---|---|
| 0 | 1st scheduled DM-RS port |
| 1 | 2nd scheduled DM-RS port |
| 2 | 3rd scheduled DM-RS port |
| 3 | 4th scheduled DM-RS port |

When two PT-RS ports are configured and a maximum rank of the scheduled PUSCH is less than or equal to four, the PT-RS/DM-RS association indication may include two bits, as shown in Table 3, below. In some such examples, the first bit (e.g., the most significant bit (MSB) may indicate with which DM-RS port a first PT-RS port is associated out of all the DM-RS ports that share (e.g., are eligible to be associated with) the first PT-RS port and that correspond to the selected codeword. The second bit (e.g., the least significant bit (LSB) may indicate with which DM-RS port a second PT-RS port is associated with out of all the DM-RS ports that share (e.g., are eligible to be associated with) the second PT-RS port and that correspond to the selected codeword.

TABLE 3
PT-RS/DM-RS association for UL PT-RS ports 0 and 1

| Value | | Value | |
|---|---|---|---|
| of | DM-RS port of the | of | DM-RS port of the |
| MSB | selected CW | LSB | selected CW |
| 0 | 1st DM-RS port which | 0 | 1st DM-RS port which |
| | shares PT-RS port 0 | | shares PT-RS port 1 |
| 1 | 2nd DM-RS port which | 1 | 2nd DM-RS port which |
| | shares PT-RS port 0 | | shares PT-RS port 1 |

When two PT-RS ports are configured and a maximum rank of the scheduled PUSCH is greater than four, the PT-RS/DM-RS association indication may include four bits, as shown in Table 4, below. In some such examples, a value (e.g., 0, 1, 2, 3) of a first subset of bits (e.g., the first two MSBs) may indicate with which DM-RS port a first PT-RS port is associated out of all the DM-RS ports that share (e.g., are eligible to be associated with) the first PT-RS port and that correspond to the selected codeword. A value of a second subset of bits (e.g., the second two LSBs) may indicate with which DM-RS port a second PT-RS port is associated with out of all the DM-RS ports that share (e.g., are eligible to be associated with) the second PT-RS port and that correspond to the selected codeword.

TABLE 4
PT-RS/DM-RS association for UL PT-RS ports 0 and 1

| Value | | Value | |
|---|---|---|---|
| of | DM-RS port of the | of | DM-RS port of the |
| MSB | selected CW | LSB | selected CW |
| 0 | 1st DM-RS port which | 0 | 1st DM-RS port which |
| | shares PT-RS port 0 | | shares PT-RS port 1 |
| 1 | 2nd DM-RS port which | 1 | 2nd DM-RS port which |
| | shares PT-RS port 0 | | shares PT-RS port 1 |
| 2 | 3rd DM-RS port which | 2 | 3rd DM-RS port which |
| | shares PT-RS port 0 | | shares PT-RS port 1 |
| 3 | 4th DM-RS port which | 3 | 4th DM-RS port which |
| | shares PT-RS port 0 | | shares PT-RS port 1 |

For non-codebook-based PUSCH transmission, an actual number of PT-RS ports (if maxNrofPorts=2) depends on the SRI field of the DCI and the selected codeword. An “actual” number of ports may correspond to a number of ports that are scheduled for transmitting PT-RS when two PT-RS ports are available. For example, a maximum number of ports may equal two, but an actual number of ports may be one or two. The SRI may indicates one or multiple SRS resources, where each SRS resource is configures with a PT-RS port index. When the indicated SRS resource (e.g., as indicated by SRI) for the selected codeword have a same PT-RS port index then an actual number of ports may equal one, otherwise an actual number of ports may equal two.

For codebook-based UL in examples where the UE 115-a is a partial-coherent UE or a non-coherent UE, the actual number of PT-RS ports may be determined based on TPMI (e.g., via a “precoding information and number of layers” field) and the selected codeword. For example, the TMPI may indicate the precoding matrix and the number of layers. The precoding matrix may indicate the association between antenna ports and each layer while the actual number of PT-RS ports may be determined based on the layers corresponding to the selected codeword.

In the example of PUSCH 220, a single PTRS port (e.g., PTRS port 0) is configured and is associated with DM-RS port 0. The UE 115-a may transmit one or more DM-RS instances and PT-RS instances via resource block 225-a and may transmit one or more DM-RS instances via resource block 225-b.

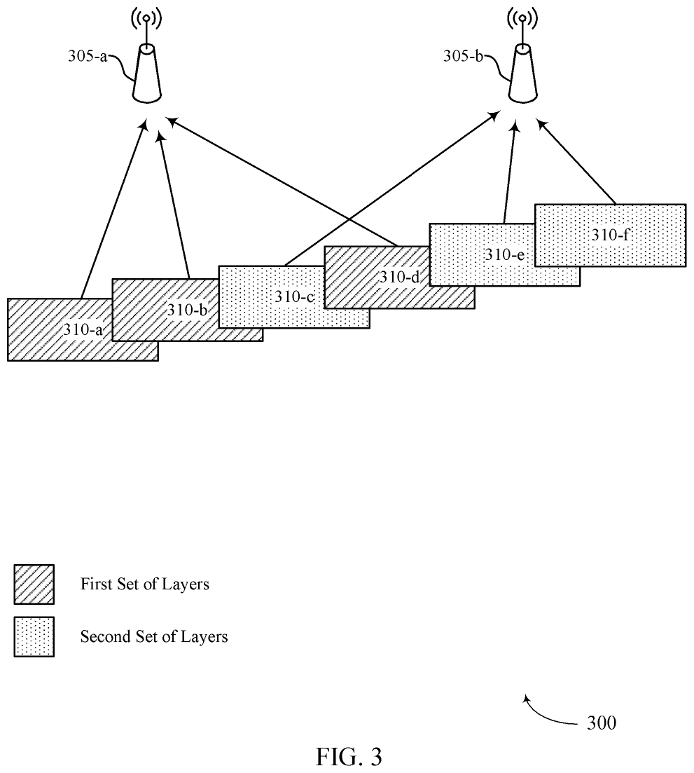

FIG. 3 illustrates an example of a wireless communications system 300 that supports reference signal association for multiple uplink codewords in accordance with one or more aspects of the present disclosure. In some examples, wireless communications system 300 may implement aspects of wireless communications system 100, or 200, or both. The wireless communications system 300 may include a TRP 305-a and a TRP 305-b, each of which may be examples of the corresponding devices as described with reference to FIG. 1. In some examples, the wireless communications system 300 may support mTRP configurations or PUSCH configurations associated with two or more sets of transmission parameters.

In the example of wireless communications system 300, a single DCI may schedule a first set of PUSCH layers for transmission to the first TRP 305-a and may schedule a second set of PUSCH layers for transmission to the second TRP 305-b. Each set of layers may be associated with a corresponding set of transmission parameters (e.g., beam/spatial relation, power control, precoding) In some examples, each set may be transmitted according to a spatial division duplexing configuration. In such examples, each set of PUSCH layers may correspond to one or more respective SRS resources with a respective SRS resource set. In some examples, each set of PUSCH layers may be mapped to one or more codewords. For example, a first codeword may be mapped to layers 310-a, 310-b, and 310-c, a second codeword may be mapped to layers 310-d, 310-e, and 310-f. Thus, the first set of PUSCH layers (e.g., transmitted to TRP 305-a) may include layers 310-a, 310-b, and 310-d, and the second set of PUSCH layers (transmitted to second TRP 305-b) may include layers 310-c, 310-e, and 310-f. The single DCI may indicate two beams or two sets of power control parameters, or both via two corresponding SRI fields for both codebook-based and non-codebook-based PUSCH.

In some examples, the first set of PUSCH layers may be associated with one or more SRS resources of a first SRS resource set and a first uplink transmission beam, or a first set of power control parameters, or a combination thereof may be used for communications with the TRP 305-a. The second set of PUSCH layers 310 may be associated with one or more SRS resources of a second SRS resource set and a second uplink transmission beam, or a second set of power control parameters, or a combination thereof may be used for communications with the TRP 305-b.

In some such examples, when a UE is scheduled with multiple codewords, DM-RS ports from one of the scheduled codewords may be used to determine the PT-RS/DM-RS association for each set of PUSCH layers. The UE may select a codeword based on an MCS value associated with each codeword or based on how many SRS resource sets with which each codeword is associated, or both.

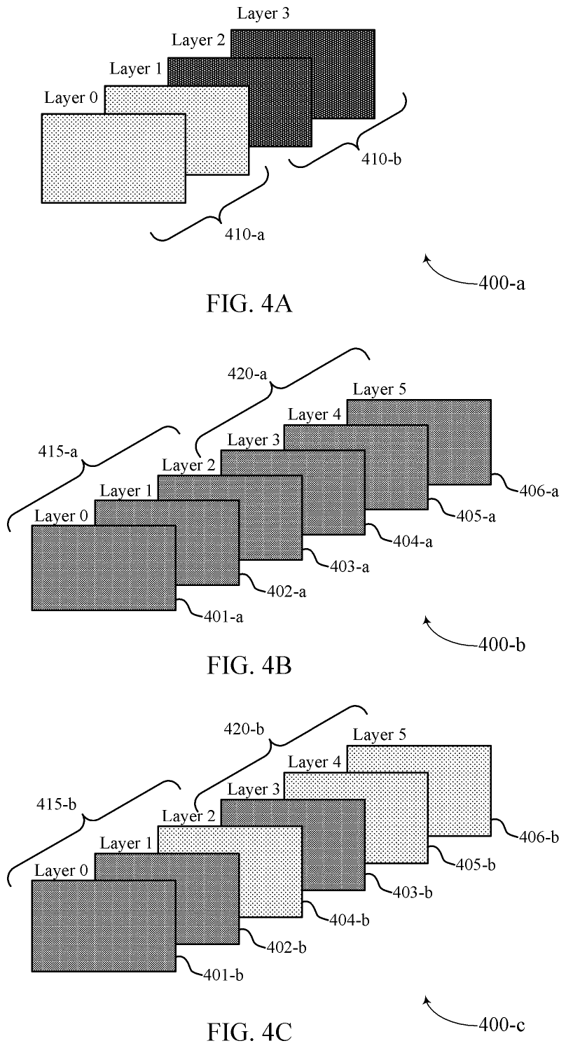

FIGS. 4A, 4B, and 4C illustrate examples of a spatial multiplexing configuration 400-a, 400-b, and 400-c that each supports reference signal association for multiple uplink codewords in accordance with one or more aspects of the present disclosure. FIG. 4A may include a first set of transmission parameters 410-a and a second set of transmission parameters 410-b. FIGS. 4B and 4C may each include a first codeword 415 and a second codeword 420.

In the example, of FIG. 4A, a PUSCH transmission may be scheduled for transmission over a number of spatial layers (e.g., layers 0-3) according to an SDM scheme where different spatial layer are associated with a corresponding set of transmission parameters 410-a or 410-b (e.g., beam configurations, power control parameters, TPMI values). In some such examples, the PUSCH transmission may include two codewords. As such, mechanisms for determining a PT-RS/DM-RS association when two CWs are scheduled for multi-layer PUSCH (i.e., sTRP PUSCH or PUSCH with single set of transmission parameters) or SDM PUSCH with different set of transmission parameters (i.e., multi-TRP SDM PUSCH) may differ from mechanisms for determining PT-RS/DM-RS when a single codeword is scheduled.

FIG. 4B illustrates an example of PT-RS/DM-RS association determination for non-codebook-based PUSCH with a single set of transmission parameters and may correspond to aspects as described with reference to FIG. 2. In some examples, a UE (e.g., a UE 115) may receive control signaling (e.g., RRC signaling) indicating a set of SRS resources. The UE may be configured with a single PT-RS port and may receive an SRI in DCI indicating that a first codeword 415-a includes or is associated with SRS resources 401-a, 402-a, and 403-a (e.g., corresponding to layers 0-2) and a second codeword 420-a includes or is associated with SRS resources 404-a, 405-a, and 406-a (e.g., corresponding to layers 3-5). In a first example of FIG. 4B, the first codeword 415-a may be associated with a higher MCS value and the UE may select first codeword 415-a for determining the PT-RS/DM-RS association according to Table 5, below.

TABLE 5
PT-RS/DM-RS association for UL PT-RS port 0

| Value | DM-RS port of the selected CW (e.g., CW0) |
|---|---|
| 0 | 1st scheduled DM-RS port → Layer 0 of CW0 |
| 1 | 2nd scheduled DM-RS port → Layer 1 of CW0 |
| 2 | 3rd scheduled DM-RS port → Layer 2 of CW0 |
| 3 | 4th scheduled DM-RS port → unused. |

In a second example of FIG. 4B, the UE may be configured with two PT-RS ports and may determine that an actual number of PT-RS ports is one because the DM-RS ports (e.g., corresponding to layers 0-2) associated with the first codeword 415-a are associated with SRS resources that are configured with a single PT-RS port (e.g., PT-RS port 0). That is, the received SRI indicated that SRS resources 401-a, 402-a, and 403-a are configured for PT-RS port 0 and thus, the second two bits or the two LSBs of the four-bit PT-RS/DM-RS association indication (e.g., because the rank of spatial multiplexing configuration 400-b equals six) may be irrelevant (e.g., unused) for indicating which DM-RS port of those associated with layers 0-3 to use for PT-RS transmission and only the first two bits or the two MSBs of the four-bits PT-RS/DM-RS association indication are used to indicate which DM-RS ports of those associated with layer 0-2 is associated with PT-RS port 0, as shown in Table 6, below.

TABLE 6
PT-RS/DM-RS association for UL PT-RS ports 0 and 1

| Value | DM-RS port of the | Value | DM-RS port of the |
|---|---|---|---|
| of | selected CW (e.g., | of | selected CW (e.g., |
| MSB | CW0) | LSB | CW0) |
| 0 | 1st DM-RS port which | 0 | unused |
| | shares PT-RS port 0 | | |
| | → Layer 0 of CW0 | | |
| 1 | 2nd DM-RS port which | 1 | |
| | shares PT-RS port 0 | | |
| | → Layer 1 of CW0 | | |
| 2 | 3rd DM-RS port which | 2 | |
| | shares PT-RS port 0 | | |
| | → Layer 2 of CW0 | | |
| 3 | unused | 3 | |

FIG. 4C illustrates an example of PT-RS/DM-RS association determination for non-codebook-based PUSCH with two or more sets of transmission parameters and may correspond to aspects as described with reference to FIG. 3.

In the example of FIG. 4C, a UE may receive a PT-RS port configuration indicating that two PT-RS ports are configured (e.g., maxNrofPorts=2). Each SRS resource may be configured with a PT-RS port index. For example, SRS resource 401-b, 402-b and 403-b in the first SRS resource set are configured with PT-RS port 0, and SRS resource 404-b, 405-b, and 406-b in the second SRS resource set are configured with PT-RS port 1. A first SRI (e.g., associated with the first set of parameters) may indicate that SRS resources 401-b, 402-b, and 403-b are associated with codeword 415-b or codeword 420-b and a second SRI (e.g., associated with the second set of parameters) may indicate that SRS resources 404-b, 405-b, and 406-b are associated with codeword 415-b or codeword 420-b. The first codeword 415-b may have or be associated with the higher MCS value in this example, and may be selected for the PT-RS/DM-RS association. As such, the PT-RS/DM-RS association indication of the DCI indicates the association for each set of DM-RS ports respectively for selected codeword 0, according to Table 7, below.

TABLE 7
PT-RS/DM-RS association for UL PT-RS port 0 and PT-RS port 1

| Value | DM-RS port of the | Value | DM-RS port of the |
|---|---|---|---|
| of | selected CW (e.g., | of | selected CW (e.g., |
| MSB | CW0) | LSB | CW0) |
| 0 | 1st DM-RS port which | 0 | unused |
| | shares PT-RS port 0 | | |
| | → Layer 0 of CW0 | | |
| 1 | 2nd DM-RS port which | 1 | |
| | shares PT-RS port 0 | | |
| | → Layer 1 of CW0 | | |

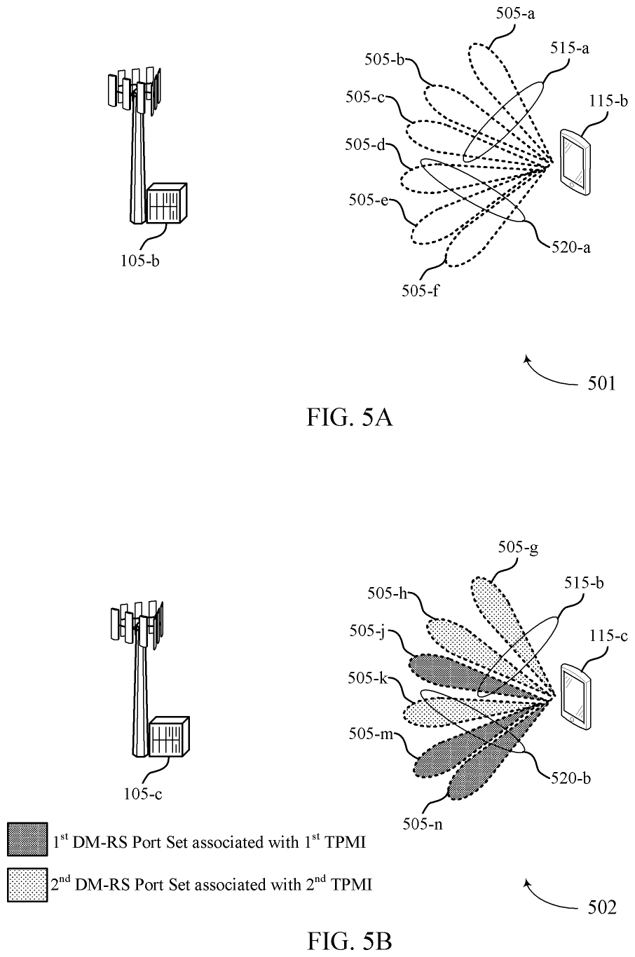

FIGS. 5A & 5B each illustrate an example of a wireless communications system 501 and 502 that supports reference signal association for multiple uplink codewords in accordance with one or more aspects of the present disclosure. Wireless communications systems 501 and 502 may each support codebook-based PUSCH transmissions (e.g., single SRS resource configurations). In the example of FIG. 5A, the wireless communications system 501 may include a network entity 105-b and a UE 115-b, each of which may be examples of the corresponding devices as described with reference to FIG. 1. The UE 115-b may be scheduled with layers 505, a first codeword 515-a, and a second codeword 520-a.

The UE 115-b may be configured with two PT-RS ports (e.g., “maxNrofPorts” may equal 2) including PT-RS port 0 and PT-RS port 1. A number of layers 505 indicated by a TPMI may be 6, where layers 505-a, 505-b, and 505-c are associated with the first codeword 515-a and layers 505-d, 505-e, and 505-f are associated with the second codeword 520-a. The UE 115-b may be configured such that PUSCH antenna port 1000 and 1002 share the first PT-RS port (e.g., PT-RS port 0) and PUSCH antenna ports 1001 and 1003 share the second PT-RS port (e.g., PT-RS port 1). Based on the TPMI indication, Layer 505-a may be associated with PUSCH antenna port 1000 and 1002, layer 505-b may be associated with PUSCH antenna port 1001, layer 505-c may be associated with PUSCH antenna port 1003, and layers 505-d, 505-e, and 505-f may be associated with PUSCH antenna ports 1001 and 1003. In some such examples, layer 505-a may be associated with the first PT-RS port (e.g., PT-RS port 0) and layers 505-b through 505-f may be associated with the second PT-RS port (e.g., PT-RS port 1).

In some such examples, when the first codeword 515-a is selected, the actual number of PT-RS ports is two, then PT-RS port 0 may be associated with layer 505-a and the first two bits (e.g., MSB) of the PT-RS/DM-RS association indication may be irrelevant because only one layer 505-a is associated with the first PT-RS port (e.g., and thus no explicit indication of DM-RS port may be needed), while the second two bits (e.g., LSB) in the PT-RS/DM-RS association indication may indicate which layer out of layers 505-b and 505-c is associated with PT-RS port 1, as demonstrated with reference to Table 8, below.

TABLE 8
PT-RS/DM-RS association for UL PT-RS
ports 0 and 1 if CW0 is selected

| Value | DM-RS port of the | Value | DM-RS port of the |
|---|---|---|---|
| of | selected codeword (e.g., | of | selected codeword (e.g., |
| MSB | CW0) | LSB | CW0) |
| 0 | Indicated DM-RS port | 0 | 1st DM-RS port which |
| | which shares PT-RS port 0 | | shares PT-RS port 1 |
| | →Layer 505-a of CW0 | | →Layer 505-b of CW0 |
| 1 | | 1 | 2nd DM-RS port which |
| | | | shares PT-RS port 1 |
| | | | →Layer 505-c of CW0 |
| 2 | | 2 | unused |
| 3 | | 3 | unused |

In some other such examples, when the second codeword 520-a is selected and the actual number of PT-RS ports is one, then the first two bits (e.g., MSB) of the PT-RS/DM-RS association indication may be unused (because, in this example, no layers of the second codeword 520-a are associated with PT-RS port 0), while the second two bits (e.g., LSB) in the PT-RS/DM-RS association indication may indicate which layer out of layers 505-d, 505-e and 505-f is associated with PT-RS port 1, as demonstrated with reference to Table 9, below.

TABLE 9
PT-RS/DM-RS association for UL PT-RS
ports 0 and 1 if CW1 is selected

| Value | DM-RS port of the | Value | DM-RS port of the |
|---|---|---|---|
| of | selected codeword (e.g., | of | selected codeword (e.g., |
| MSB | CW1) | LSB | CW1) |
| 0 | Unused | 0 | 1st DM-RS port which |
| | | | shares PT-RS port 1 |
| | | | →Layer 505-d of CW1 |
| 1 | | 1 | 2nd DM-RS port which |
| | | | shares PT-RS port 1 |
| | | | →Layer 505-e of CW1 |
| 2 | | 2 | 3rd DM-RS port which |
| | | | shares PT-RS port 1 |
| | | | →Layer 505-f of CW1 |
| 3 | | 3 | Unused |

In the example of FIG. 5B, the wireless communications system 502 may include a network entity 105-c and a UE 115-c, each of which may be examples of the corresponding devices as described with reference to FIG. 1. The UE 115-c may be scheduled with layers 505, a first codeword 515-b and a second codeword 520-b, where layers 505-g, 505-h, and 505-j are associated with the first codeword 515-b and layers 505-k, 505-m, and 505-n are associated with the second codeword 520-b.

The UE 115-c may be configured with two PT-RS ports (e.g., maxNrofPorts may equal 2) including a first PT-RS port (e.g., PT-RS port 0) and a second PT-RS port (e.g., PT-RS port 1). A number of layers 505 indicated by the TPMI may be six, where layers 505-g, 505-h, and 505-k are associated with a first TPMI and layers 505-j, 505-m, and 505-n are associated with a second TPMI. The DM-RS ports associated with the first TPMI may share the first PT-RS port (e.g., PT-RS port 0) and the DM-RS ports associated with the second TPMI may share the second PT-RS port (e.g., PT-RS port 1). In some such examples, layers 505-g, 505-h, and 505-k may be associated with a first PT-RS port and layers 505-j, 505-m, and 505-n may be associated with the second PT-RS port.

In some such examples, as shown in Table 10, below, when the UE 115-c selects a first codeword 515-b (e.g., codeword 0) out of the scheduled codewords, the actual number of PT-RS ports is two, then a first bit (MSB) in the PT-RS/DM-RS association indication may indicate which layer out of layers 505-g and 505-h are associated with the first PT-RS port and a second bit (e.g., LSB) may remain unused or may be irrelevant as the second PT-RS port is associated with a single layer 505-j within the selected CW and thus does not need to be explicitly indicated (e.g., may be unused or irrelevant).

TABLE 10
PT-RS/DM-RS association for UL PT-RS
ports 0 and 1 if CW0 is selected

| Value | DM-RS port of the | Value | DM-RS port of the |
|---|---|---|---|
| of | selected CW (e.g., | of | selected CW (e.g., |
| MSB | CW0) | LSB | CW0) |
| 0 | 1st DM-RS port which | 0 | unused |
| | shares PT-RS port | | |
| | 0→Layer 505-g of CW0 | | |
| 1 | 2nd DM-RS port which | 1 | |
| | shares PT-RS port | | |
| | 0→Layer 505-h of CW0 | | |

In some such examples, as shown in Table 11 below, when the UE 115-c selects a second codeword 520-b (e.g., codeword 1) out of the scheduled codewords, the actual number of PT-RS ports is two, then a first bit (MSB) in the PT-RS/DM-RS association indication may be unused or irrelevant as the first PT-RS port (e.g., PT-RS port 0) is associated with single layer 505-k (e.g., DM-RS port) within the selected second codeword 520-b and a second bit (e.g., LSB) may indicate which layer out of layers 505-m and 505-n is associated with the second PT-RS port (e.g., PT-RS port 1).

TABLE 11
PT-RS/DM-RS association for UL PT-RS
ports 0 and 1 if CW1 is selected

| Value | DM-RS port of the | Value | DM-RS port of the |
|---|---|---|---|
| of | selected CW (e.g., | of | selected CW (e.g., |
| MSB | CW0) | LSB | CW0) |
| 0 | Unused | 0 | 1st DM-RS port which |
| | | | shares PT-RS port |
| | | | 1→Layer 505-m of CW1 |
| 1 | | 1 | 2nd DM-RS port which |
| | | | shares PT-RS port |
| | | | 1→Layer 505-n of CW1 |

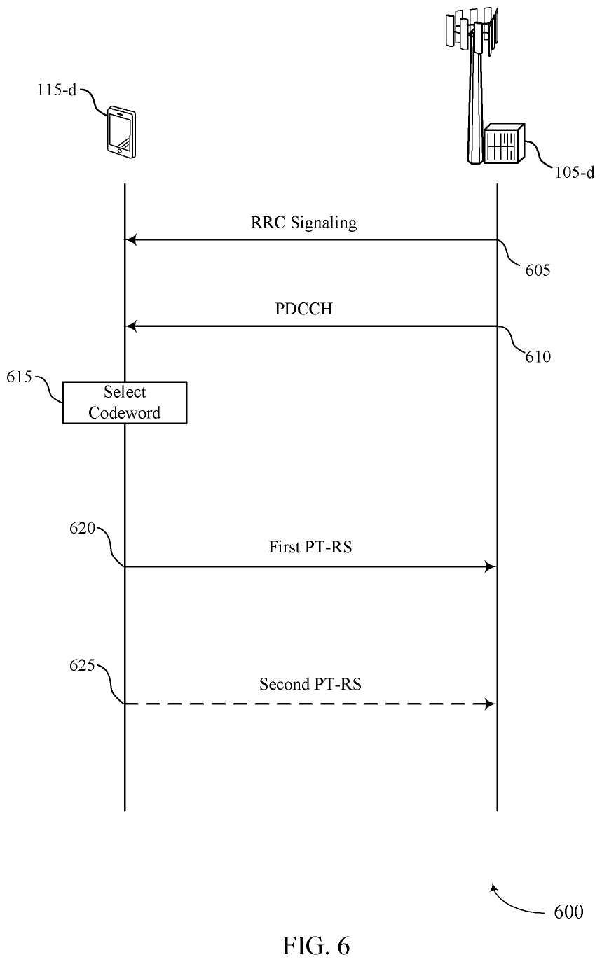

FIG. 6 illustrates an example of a process flow 600 that supports reference signal association for multiple uplink codewords in accordance with one or more aspects of the present disclosure. The process flow 600 may implement or be implemented by aspects of wireless communications system 100, 200, 501, or 502. For example, the process flow 600 may illustrate operations between a UE 115-d and a network entity 105-d, which may be examples of a UE 115 and a network entity 105, as described with reference to FIG. 1. In the following description of the process flow 600, the operations between the UE 115-d and the network entity 105-d may be transmitted in a different order than the example order shown, or the operations performed by the UE 115-d and the network entity 105-d may be performed in different orders or at different times or by different devices. Some operations may also be omitted from the process flow 600, and other operations may be added to the process flow 600.

At 605, the network entity 105-d may transmit RRC signaling to the UE 115-d. In some examples, the RRC signaling may include an indication of a transmission mode (e.g., codebook-based PUSCH transmission or non-codebook-based transmission) for a PUSCH and a PT-RS configuration. In some examples, the PT-RS signal indication may indicate a number of configured PT-RS ports, or a density of PT-RS occasions in the frequency domain, or the time domain, or both. In some examples, the RRC signaling may include an indication of a first codeword or a second codeword which the UE is to select for determining a PT-RS/DM-RS association.

At 610, the network entity 105-d may transmit a downlink control channel (e.g., PDCCH) including DCI. The DCI may include an indication of a PT-RS/DM-RS association based on the PT-RS configuration (e.g., the number of available ports). In some examples, the DCI schedules resources for a PUSCH transmission as well as a first codeword and a second codeword for uplink data transmission. In some examples, the DCI may include an indication of the first codeword or the second codeword which the UE is to select for determining the PT-RS/DM-RS association. In some examples, the DCI may further include an SRS resource indicator that indicates a plurality of SRS resources, where each SRS resource of the plurality may be associated with one of the plurality of available PT-RS ports. In some examples, the DCI may include a TPMI, where the TPMI indicates a set of antenna ports for transmitting the PUSCH and indicates a precoding matrix comprising an association between the set of DM-RS ports and the set of antenna ports.

At 615, the UE 115-d may select a codeword from the plurality of scheduled codewords. For example, the UE 115-d may select the first codeword associated with a first MCS value that is larger than a second MCS value associated with the second codeword. In some examples, the UE 115-d may select the first codeword based on the first codeword being associated with at least two SRS resource sets, at least two precoders, or both. In some examples, the UE 115-d may select the first codeword associated with a first index and a first MCS value when the second codeword is associated with a second index that is greater than the first index and a second MCS value that is equal to the first MCS value. In some examples, the UE 115-d may select a codeword indicated by DCI or RRC signaling.

At 620, the UE 115-d may transmit a first PTRS instance. For example, the UE 115-d may transmit a first PTRS instance, via one or more resources of the PUSCH according to the transmission mode, using a PTRS port corresponding to a DM-RS port of a set of DM-RS ports associated with the selected codeword based on the indicated association.

At 625, the UE 115-d may transmit a second PTRS instance. For example, the UE 115-d may transmit a second PT-RS corresponding to a second DM-RS port of a second set of DM-RS ports associated with the selected codeword based on the association.

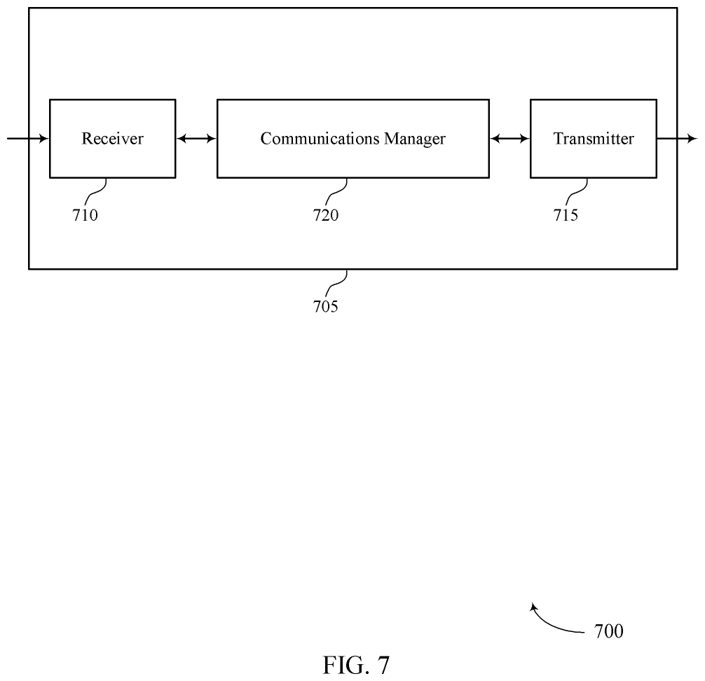

FIG. 7 shows a block diagram 700 of a device 705 that supports reference signal association for multiple uplink codewords in accordance with one or more aspects of the present disclosure. The device 705 may be an example of aspects of a UE 115 as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the codeword selection features discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to reference signal association for multiple uplink codewords). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reference signal association for multiple uplink codewords). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of reference signal association for multiple uplink codewords as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving radio resource control signaling including an indication of a transmission mode for a physical uplink shared channel and a phase tracking reference signal (PT-RS) configuration. The communications manager 720 may be configured as or otherwise support a means for receiving downlink control information including an indication of an association between PT-RS ports and DM-RS ports based on the PT-RS configuration, where the downlink control information schedules a first codeword and a second codeword for an uplink transmission. The communications manager 720 may be configured as or otherwise support a means for selecting a codeword from the first codeword and the second codeword for the uplink transmission. The communications manager 720 may be configured as or otherwise support a means for transmitting, via the physical uplink shared channel according to the transmission mode, a PT-RS corresponding to a DM-RS port of a set of DM-RS ports associated with the selected codeword based on the association.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for increased data rates, increased capacity, higher reliability communications, and increased spectral efficiency among other examples.

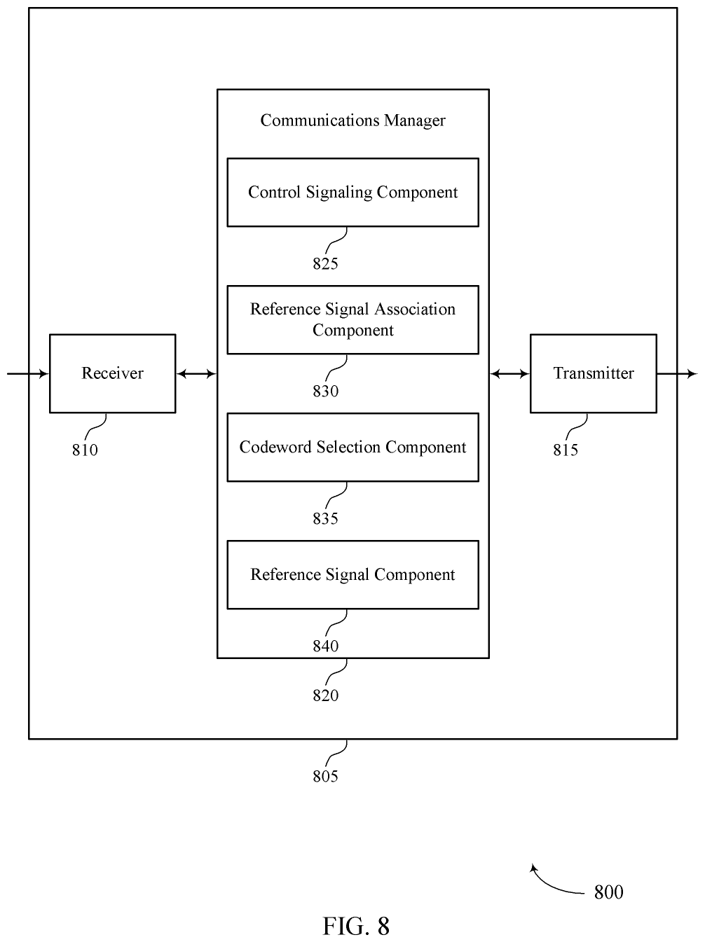

FIG. 8 shows a block diagram 800 of a device 805 that supports reference signal association for multiple uplink codewords in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to reference signal association for multiple uplink codewords). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to reference signal association for multiple uplink codewords). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of reference signal association for multiple uplink codewords as described herein. For example, the communications manager 820 may include a control signaling component 825, a reference signal association component 830, a codeword selection component 835, a reference signal component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The control signaling component 825 may be configured as or otherwise support a means for receiving radio resource control signaling including an indication of a transmission mode for a physical uplink shared channel and a phase tracking reference signal (PT-RS) configuration. The reference signal association component 830 may be configured as or otherwise support a means for receiving downlink control information including an indication of an association between PT-RS ports and DM-RS ports based on the PT-RS configuration, where the downlink control information schedules a first codeword and a second codeword for an uplink transmission. The codeword selection component 835 may be configured as or otherwise support a means for selecting a codeword from the first codeword and the second codeword for the uplink transmission. The reference signal component 840 may be configured as or otherwise support a means for transmitting, via the physical uplink shared channel according to the transmission mode, a PT-RS corresponding to a DM-RS port of a set of DM-RS ports associated with the selected codeword based on the association.

In some cases, the control signaling component 825, the reference signal association component 830, the codeword selection component 835, and the reference signal component 840 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling component 825, the reference signal association component 830, the codeword selection component 835, and the reference signal component 840 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

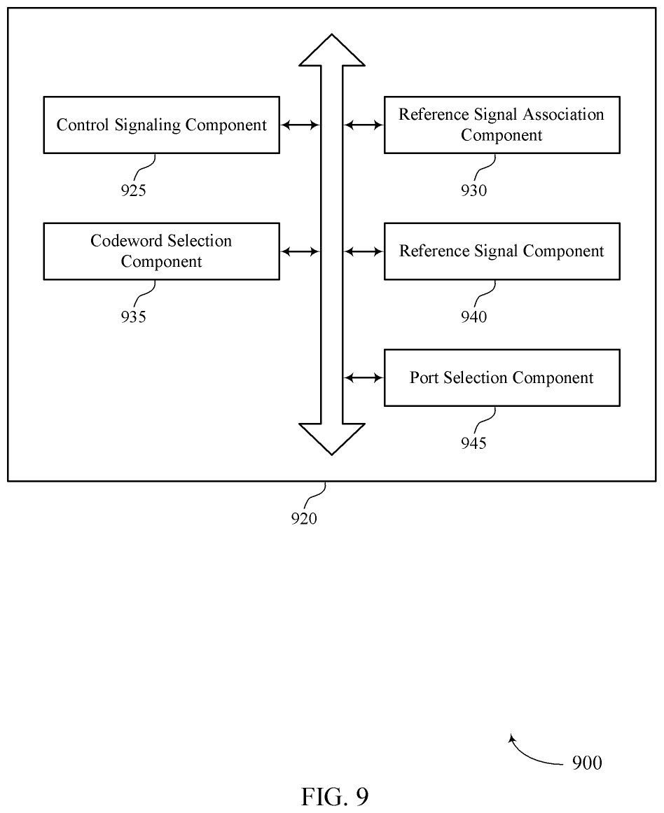

FIG. 9 shows a block diagram 900 of a communications manager 920 that supports reference signal association for multiple uplink codewords in accordance with one or more aspects of the present disclosure. The communications manager 920 may be an example of aspects of a communications manager 720, a communications manager 820, or both, as described herein. The communications manager 920, or various components thereof, may be an example of means for performing various aspects of reference signal association for multiple uplink codewords as described herein. For example, the communications manager 920 may include a control signaling component 925, a reference signal association component 930, a codeword selection component 935, a reference signal component 940, a port selection component 945, or any combination thereof. Each of these components may communicate, directly or indirectly, with one another (e.g., via one or more buses).

The communications manager 920 may support wireless communication at a UE in accordance with examples as disclosed herein. The control signaling component 925 may be configured as or otherwise support a means for receiving radio resource control signaling including an indication of a transmission mode for a physical uplink shared channel and a phase tracking reference signal (PT-RS) configuration. The reference signal association component 930 may be configured as or otherwise support a means for receiving downlink control information including an indication of an association between PT-RS ports and DM-RS ports based on the PT-RS configuration, where the downlink control information schedules a first codeword and a second codeword for an uplink transmission. The codeword selection component 935 may be configured as or otherwise support a means for selecting a codeword from the first codeword and the second codeword for the uplink transmission. The reference signal component 940 may be configured as or otherwise support a means for transmitting, via the physical uplink shared channel according to the transmission mode, a PT-RS corresponding to a DM-RS port of a set of DM-RS ports associated with the selected codeword based on the association.

In some examples, to support selecting the codeword, the codeword selection component 935 may be configured as or otherwise support a means for selecting the first codeword associated with a first modulation and coding scheme value, where the second codeword is associated with a second modulation and coding scheme value that is less than the first modulation and coding scheme value.

In some examples, the reference signal association component 930 may be configured as or otherwise support a means for determining that the first codeword associated with the first modulation and coding scheme value is associated with at least two SRS resource sets, at least two precoders, or both based on the PT-RS configuration indicating at least two available ports for transmitting one or more PT-RSs, where the physical uplink shared channel is associated with a first set of transmission parameters and a second set of transmission parameters.

In some examples, the reference signal component 940 may be configured as or otherwise support a means for transmitting a second PT-RS corresponding to a second DM-RS port of a second set of DM-RS ports associated with the selected codeword based on the association.

In some examples, to support selecting the codeword, the codeword selection component 935 may be configured as or otherwise support a means for selecting the first codeword based on the first codeword being associated with at least two SRS resource sets, at least two precoders, or both.

In some examples, the reference signal association component 930 may be configured as or otherwise support a means for determining that a second codeword is associated with at least two SRS resource sets, at least two precoders, or both, where selecting the first codeword is further based on a modulation and coding scheme value of the first codeword, an index of the first codeword, or both.

In some examples, to support selecting the codeword, the codeword selection component 935 may be configured as or otherwise support a means for selecting the first codeword associated with a first index and a first modulation and coding scheme value, where the second codeword is associated with a second index that is greater than the first index and a second modulation and coding scheme value that is equal to the first modulation and coding scheme value.

In some examples, the radio resource control signaling, or the downlink control information, or both includes an indication of the first codeword or the second codeword. In some examples, selecting the codeword includes. In some examples, selecting the indicated codeword.

In some examples, the PT-RS configuration indicates a single available port for transmitting a PT-RS and the transmission mode is codebook-based or non-codebook-based. In some examples, the indication of the association includes two bits indicating a DM-RS port of the set of DM-RS ports associated with the selected codeword. In some examples, the PT-RS configuration indicates a set of multiple available ports for transmitting one or more PT-RSs.

In some examples, the indication of the association includes at least two bits, and the reference signal component 940 may be configured as or otherwise support a means for transmitting a second PT-RS corresponding to the second DM-RS port of the second set of DM-RS ports associated with the selected codeword based on the association. In some examples, a rank of the physical uplink shared channel is less than or equal to a threshold rank.

In some examples, the set of DM-RS ports are associated with a first SRS resource set, a first precoder, or both and the second set of DM-RS ports are associated with a second SRS resource set, a second precoder, or both.

In some examples, the indication of the association includes a set of multiple bits, and the reference signal component 940 may be configured as or otherwise support a means for transmitting a second PT-RS corresponding to the second DM-RS port of the second set of DM-RS ports associated with the selected codeword based on the association.

In some examples, a rank of the physical uplink shared channel is greater than a threshold rank. In some examples, the set of DM-RS ports is associated with a first port for transmitting the PT-RS and a second set of ports is associated with a second port for transmitting a second PT-RS. In some examples, the transmission mode is non-codebook-based.

In some examples, the downlink control information further includes an SRS resource indicator that indicates a set of multiple SRS resources, and the port selection component 945 may be configured as or otherwise support a means for determining which of the set of multiple available ports to use for transmitting the one or more PT-RSs based on the selected codeword and the SRS resource indicator, where each SRS resource is associated with one of the set of multiple available ports for transmitting one or more PT-RSs.

In some examples, to support determining which of the set of multiple available ports to use for transmitting the one or more PT-RSs, the port selection component 945 may be configured as or otherwise support a means for determining to use one of the set of multiple available ports based on an PT-RS port index associated with each SRS resource of the SRS resources associated with the selected codeword being the same. In some examples, to support determining which of the set of multiple available ports to use for transmitting the one or more PT-RSs, the port selection component 945 may be configured as or otherwise support a means for determining to use two or more of the set of multiple available ports based on an PT-RS port index associated with multiple SRS resource associated with the selected codeword being different. In some examples, the transmission mode is codebook-based.

In some examples, the downlink control information further includes a transmit precoding matrix index, and the port selection component 945 may be configured as or otherwise support a means for determining which of the set of multiple available ports to use for transmitting the one or more PT-RSs based on the selected codeword and the transmit precoding matrix index, where the transmit precoding matrix index indicates a set of antenna ports for transmitting the physical uplink shared channel and a precoding matrix including an association between the set of DM-RS ports and the set of antenna ports.

In some examples, to support determining which of the set of multiple available ports to use for transmitting the one or more PT-RSs, the port selection component 945 may be configured as or otherwise support a means for determining to use one or more of the set of multiple available ports based on the association between the set of DM-RS ports and the set of antenna ports.

In some examples, the physical uplink shared channel is associated with a first set of transmission parameters and a second set of transmission parameters.

In some cases, the control signaling component 925, the reference signal association component 930, the codeword selection component 935, the reference signal component 940, and the port selection component 945 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling component 925, the reference signal association component 930, the codeword selection component 935, the reference signal component 940, and the port selection component 945 discussed herein.

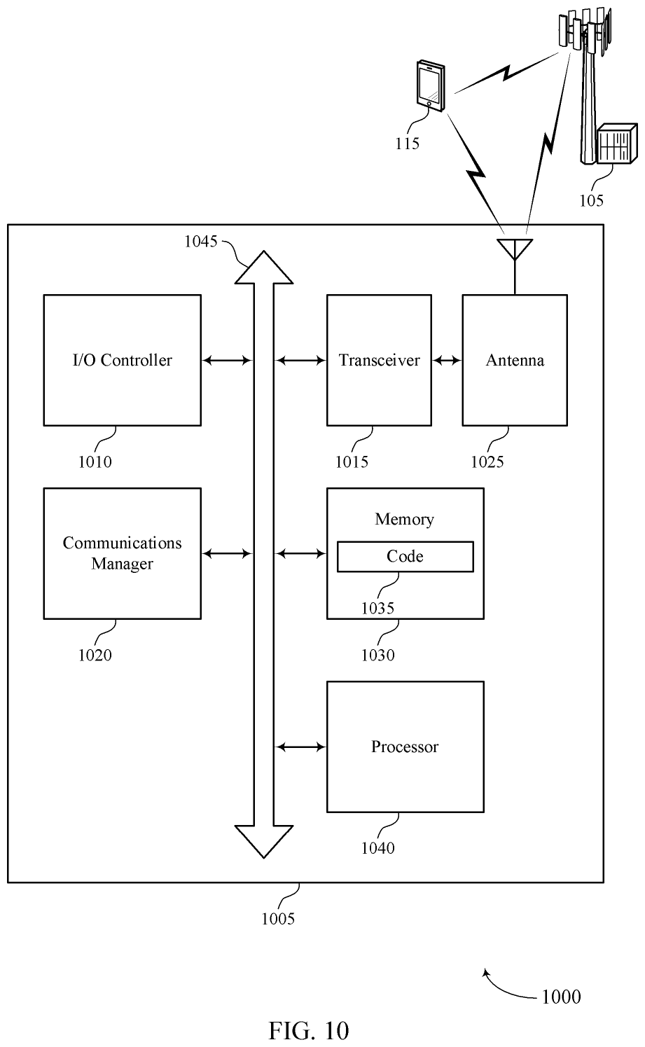

FIG. 10 shows a diagram of a system 1000 including a device 1005 that supports reference signal association for multiple uplink codewords in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting reference signal association for multiple uplink codewords). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving radio resource control signaling including an indication of a transmission mode for a physical uplink shared channel and a phase tracking reference signal (PT-RS) configuration. The communications manager 1020 may be configured as or otherwise support a means for receiving downlink control information including an indication of an association between PT-RS ports and DM-RS ports based on the PT-RS configuration, where the downlink control information schedules a first codeword and a second codeword for an uplink transmission. The communications manager 1020 may be configured as or otherwise support a means for selecting a codeword from the first codeword and the second codeword for the uplink transmission. The communications manager 1020 may be configured as or otherwise support a means for transmitting, via the physical uplink shared channel according to the transmission mode, a PT-RS corresponding to a DM-RS port of a set of DM-RS ports associated with the selected codeword based on the association.

By including or configuring the communications manager 1020 in accordance with examples as described herein, the device 1005 may support techniques for improved communication reliability, improved user experience, more efficient utilization of communication resources, improved coordination between devices, and improved utilization of processing capability, among other examples.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of reference signal association for multiple uplink codewords as described herein, or the processor 1040 and the memory 1030 may be otherwise configured to perform or support such operations.

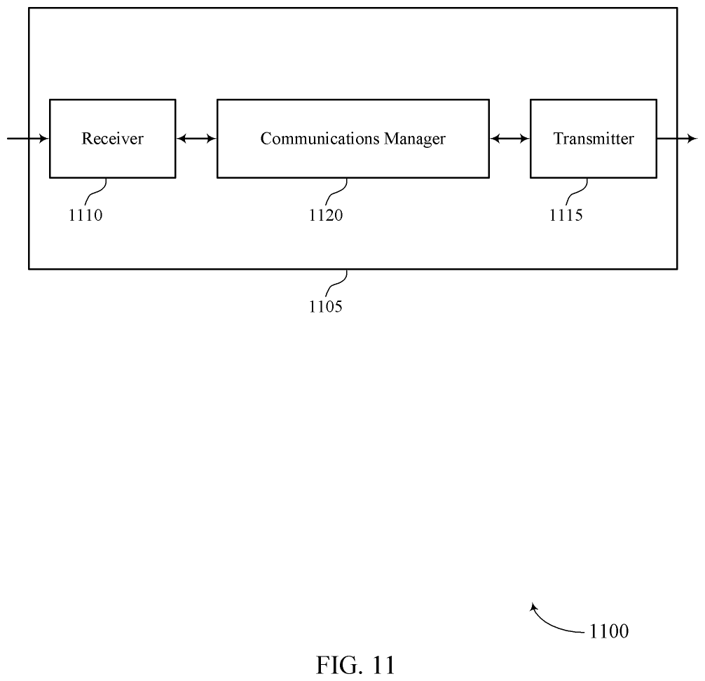

FIG. 11 shows a block diagram 1100 of a device 1105 that supports reference signal association for multiple uplink codewords in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include one or more processors, memory coupled with the one or more processors, and instructions stored in the memory that are executable by the one or more processors to enable the one or more processors to perform the codeword selection features discussed herein. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of reference signal association for multiple uplink codewords as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 may be configured as or otherwise support a means for transmitting radio resource control signaling including an indication of a transmission mode for a physical uplink shared channel and a phase tracking reference signal (PT-RS) configuration. The communications manager 1120 may be configured as or otherwise support a means for transmitting downlink control information including an indication of an association between PT-RS ports and DM-RS ports based on the PT-RS configuration, where the downlink control information schedules a first codeword and a second codeword for an uplink transmission. The communications manager 1120 may be configured as or otherwise support a means for receiving, via the physical uplink shared channel according to the transmission mode, a PT-RS corresponding to a DM-RS port of a set of DM-RS ports associated with a selected codeword based on the association.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for increased data rates, increased capacity, higher reliability communications, and increased spectral efficiency among other examples.

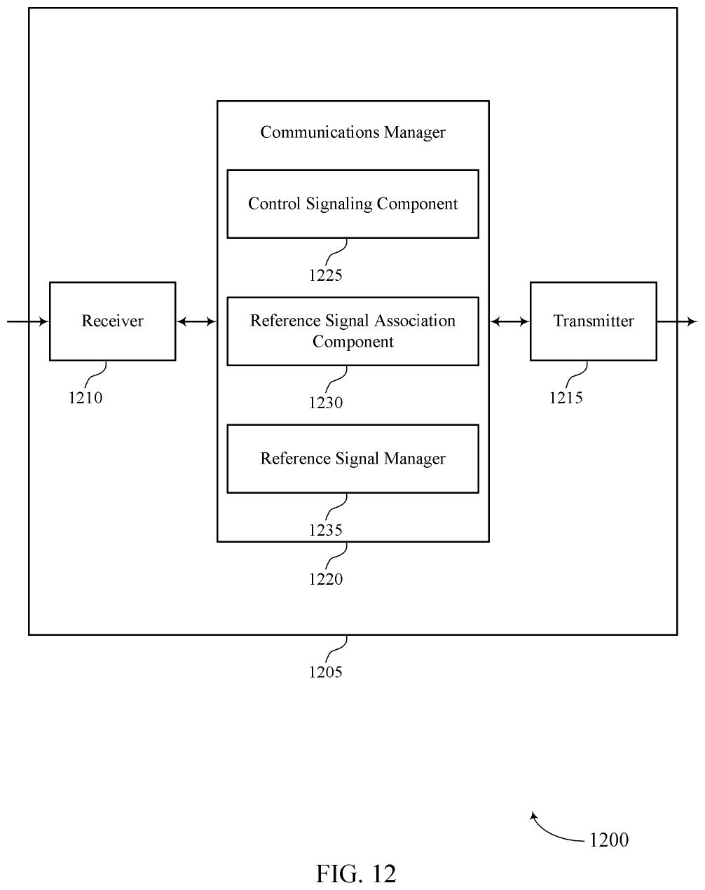

FIG. 12 shows a block diagram 1200 of a device 1205 that supports reference signal association for multiple uplink codewords in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of reference signal association for multiple uplink codewords as described herein. For example, the communications manager 1220 may include a control signaling component 1225, a reference signal association component 1230, a reference signal manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The control signaling component 1225 may be configured as or otherwise support a means for transmitting radio resource control signaling including an indication of a transmission mode for a physical uplink shared channel and a phase tracking reference signal (PT-RS) configuration. The reference signal association component 1230 may be configured as or otherwise support a means for transmitting downlink control information including an indication of an association between PT-RS ports and DM-RS ports based on the PT-RS configuration, where the downlink control information schedules a first codeword and a second codeword for an uplink transmission. The reference signal manager 1235 may be configured as or otherwise support a means for receiving, via the physical uplink shared channel according to the transmission mode, a PT-RS corresponding to a DM-RS port of a set of DM-RS ports associated with a selected codeword based on the association.

In some cases, the control signaling component 1225, the reference signal association component 1230, and the reference signal manager 1235 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling component 1225, the reference signal association component 1230, and the reference signal manager 1235 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

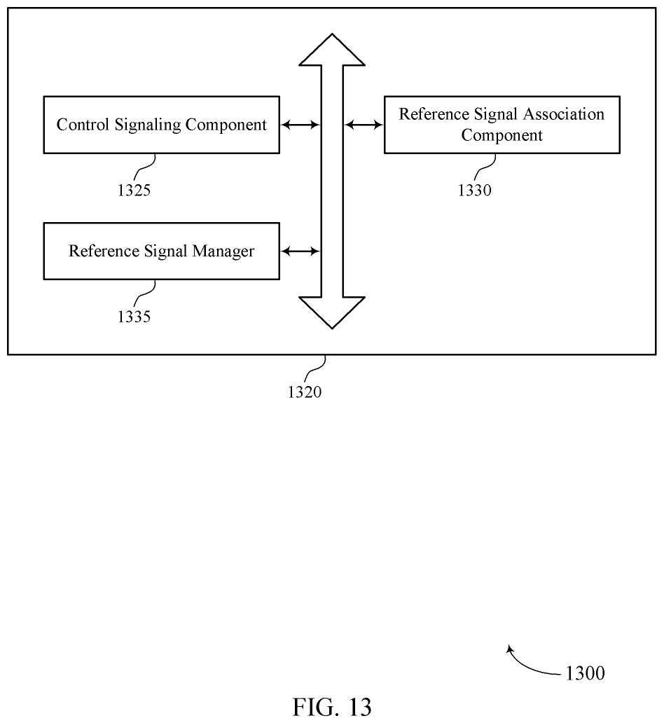

FIG. 13 shows a block diagram 1300 of a communications manager 1320 that supports reference signal association for multiple uplink codewords in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of reference signal association for multiple uplink codewords as described herein. For example, the communications manager 1320 may include a control signaling component 1325, a reference signal association component 1330, a reference signal manager 1335, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The control signaling component 1325 may be configured as or otherwise support a means for transmitting radio resource control signaling including an indication of a transmission mode for a physical uplink shared channel and a phase tracking reference signal (PT-RS) configuration. The reference signal association component 1330 may be configured as or otherwise support a means for transmitting downlink control information including an indication of an association between PT-RS ports and DM-RS ports based on the PT-RS configuration, where the downlink control information schedules a first codeword and a second codeword for an uplink transmission. The reference signal manager 1335 may be configured as or otherwise support a means for receiving, via the physical uplink shared channel according to the transmission mode, a PT-RS corresponding to a DM-RS port of a set of DM-RS ports associated with a selected codeword based on the association.

In some examples, the reference signal manager 1335 may be configured as or otherwise support a means for receiving a second PT-RS corresponding to a second DM-RS port of the set of DM-RS ports associated with the selected codeword based on the association.

In some examples, the indication of the association includes at least two bits indicating the DM-RS port of the set of DM-RS ports associated with the selected codeword.

In some cases, the control signaling component 1325, the reference signal association component 1330, and the reference signal manager 1335 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling component 1325, the reference signal association component 1330, and the reference signal manager 1335 discussed herein.

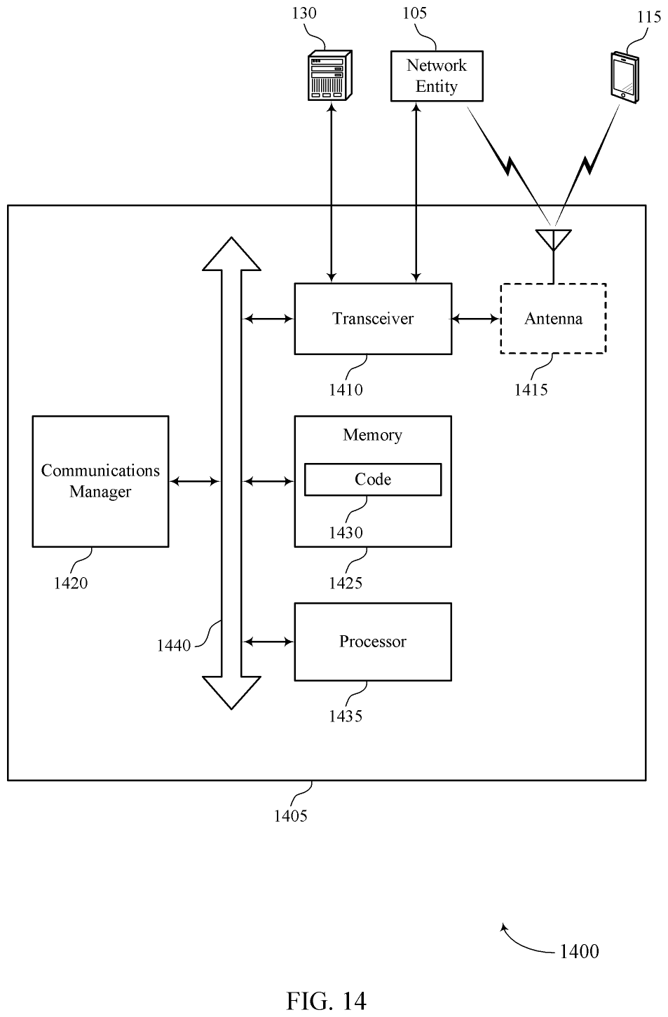

FIG. 14 shows a diagram of a system 1400 including a device 1405 that supports reference signal association for multiple uplink codewords in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting reference signal association for multiple uplink codewords). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 may be configured as or otherwise support a means for transmitting radio resource control signaling including an indication of a transmission mode for a physical uplink shared channel and a phase tracking reference signal (PT-RS) configuration. The communications manager 1420 may be configured as or otherwise support a means for transmitting downlink control information including an indication of an association between PT-RS ports and DM-RS ports based on the PT-RS configuration, where the downlink control information schedules a first codeword and a second codeword for an uplink transmission. The communications manager 1420 may be configured as or otherwise support a means for receiving, via the physical uplink shared channel according to the transmission mode, a PT-RS corresponding to a DM-RS port of a set of DM-RS ports associated with a selected codeword based on the association.

By including or configuring the communications manager 1420 in accordance with examples as described herein, the device 1405 may support techniques for improved communication reliability, improved user experience, more efficient utilization of communication resources, improved coordination between devices, and improved utilization of processing capability, among other examples.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of reference signal association for multiple uplink codewords as described herein, or the processor 1435 and the memory 1425 may be otherwise configured to perform or support such operations.

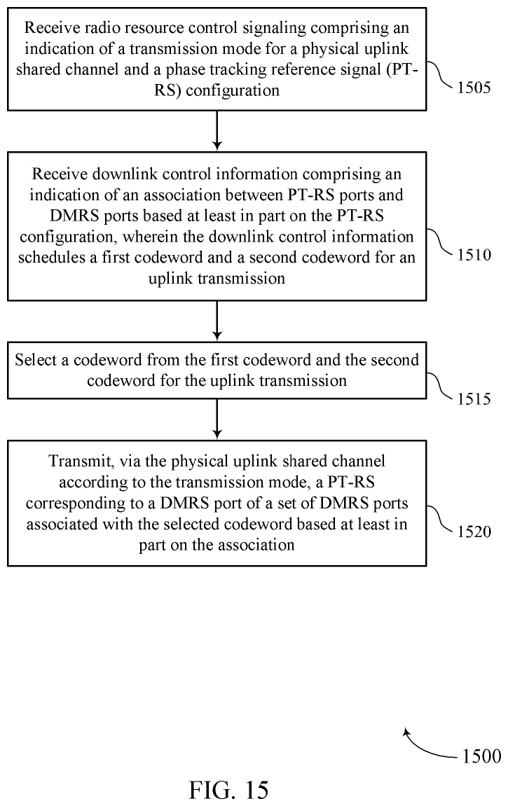

FIG. 15 shows a flowchart illustrating a method 1500 that supports reference signal association for multiple uplink codewords in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving radio resource control signaling including an indication of a transmission mode for a physical uplink shared channel and a phase tracking reference signal (PT-RS) configuration. The operations of 1505 may be performed in accordance with examples as disclosed herein. In some examples, aspects of the operations of 1505 may be performed by a control signaling component 925 as described with reference to FIG. 9.

At 1510, the method may include receiving downlink control information including an indication of an association between PT-RS ports and DM-RS ports based on the PT-RS configuration, where the downlink control information schedules a first codeword and a second codeword for an uplink transmission. The operations of 1510 may be performed in accordance with examples as disclosed herein. In some examples, aspects of the operations of 1510 may be performed by a reference signal association component 930 as described with reference to FIG. 9.

At 1515, the method may include selecting a codeword from the first codeword and the second codeword for the uplink transmission. The operations of 1515 may be performed in accordance with examples as disclosed herein. In some examples, aspects of the operations of 1515 may be performed by a codeword selection component 935 as described with reference to FIG. 9.

At 1520, the method may include transmitting, via the physical uplink shared channel according to the transmission mode, a PT-RS corresponding to a DM-RS port of a set of DM-RS ports associated with the selected codeword based on the association. The operations of 1520 may be performed in accordance with examples as disclosed herein. In some examples, aspects of the operations of 1520 may be performed by a reference signal component 940 as described with reference to FIG. 9.

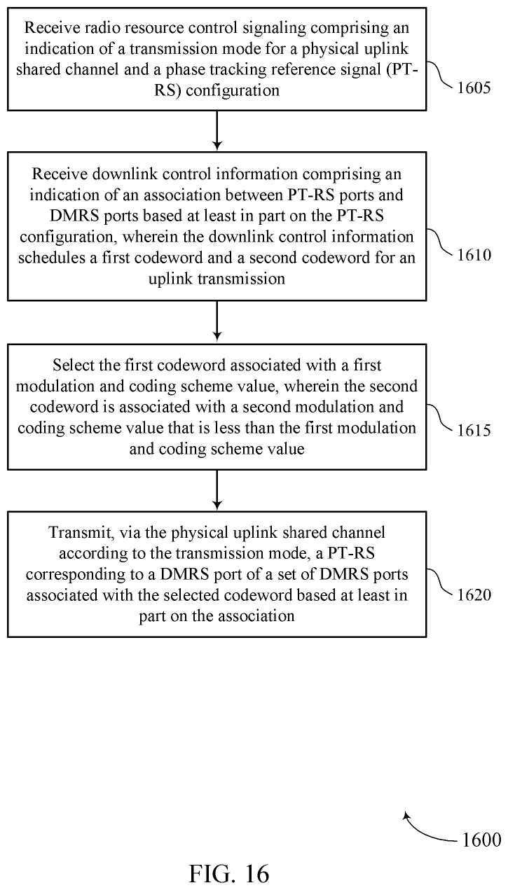

FIG. 16 shows a flowchart illustrating a method 1600 that supports reference signal association for multiple uplink codewords in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving radio resource control signaling including an indication of a transmission mode for a physical uplink shared channel and a phase tracking reference signal (PT-RS) configuration. The operations of 1605 may be performed in accordance with examples as disclosed herein. In some examples, aspects of the operations of 1605 may be performed by a control signaling component 925 as described with reference to FIG. 9.

At 1610, the method may include receiving downlink control information including an indication of an association between PT-RS ports and DM-RS ports based on the PT-RS configuration, where the downlink control information schedules a first codeword and a second codeword for an uplink transmission. The operations of 1610 may be performed in accordance with examples as disclosed herein. In some examples, aspects of the operations of 1610 may be performed by a reference signal association component 930 as described with reference to FIG. 9.

At 1615, the method may include selecting the first codeword associated with a first modulation and coding scheme value, where the second codeword is associated with a second modulation and coding scheme value that is less than the first modulation and coding scheme value. The operations of 1615 may be performed in accordance with examples as disclosed herein. In some examples, aspects of the operations of 1615 may be performed by a codeword selection component 935 as described with reference to FIG. 9.

At 1620, the method may include transmitting, via the physical uplink shared channel according to the transmission mode, a PT-RS corresponding to a DM-RS port of a set of DM-RS ports associated with the selected codeword based on the association. The operations of 1620 may be performed in accordance with examples as disclosed herein. In some examples, aspects of the operations of 1620 may be performed by a reference signal component 940 as described with reference to FIG. 9.

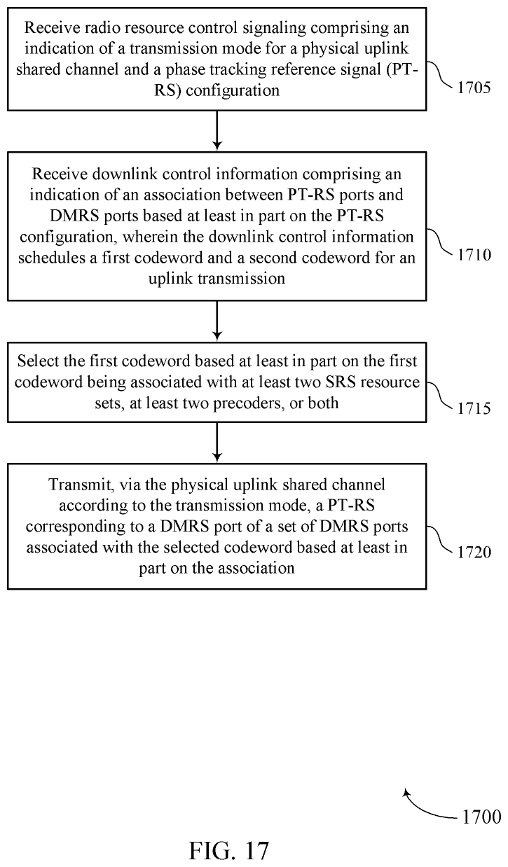

FIG. 17 shows a flowchart illustrating a method 1700 that supports reference signal association for multiple uplink codewords in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving radio resource control signaling including an indication of a transmission mode for a physical uplink shared channel and a phase tracking reference signal (PT-RS) configuration. The operations of 1705 may be performed in accordance with examples as disclosed herein. In some examples, aspects of the operations of 1705 may be performed by a control signaling component 925 as described with reference to FIG. 9.

At 1710, the method may include receiving downlink control information including an indication of an association between PT-RS ports and DM-RS ports based on the PT-RS configuration, where the downlink control information schedules a first codeword and a second codeword for an uplink transmission. The operations of 1710 may be performed in accordance with examples as disclosed herein. In some examples, aspects of the operations of 1710 may be performed by a reference signal association component 930 as described with reference to FIG. 9.

At 1715, the method may include selecting the first codeword based on the first codeword being associated with at least two SRS resource sets, at least two precoders, or both. The operations of 1715 may be performed in accordance with examples as disclosed herein. In some examples, aspects of the operations of 1715 may be performed by a codeword selection component 935 as described with reference to FIG. 9.

At 1720, the method may include transmitting, via the physical uplink shared channel according to the transmission mode, a PT-RS corresponding to a DM-RS port of a set of DM-RS ports associated with the selected codeword based on the association. The operations of 1720 may be performed in accordance with examples as disclosed herein. In some examples, aspects of the operations of 1720 may be performed by a reference signal component 940 as described with reference to FIG. 9.

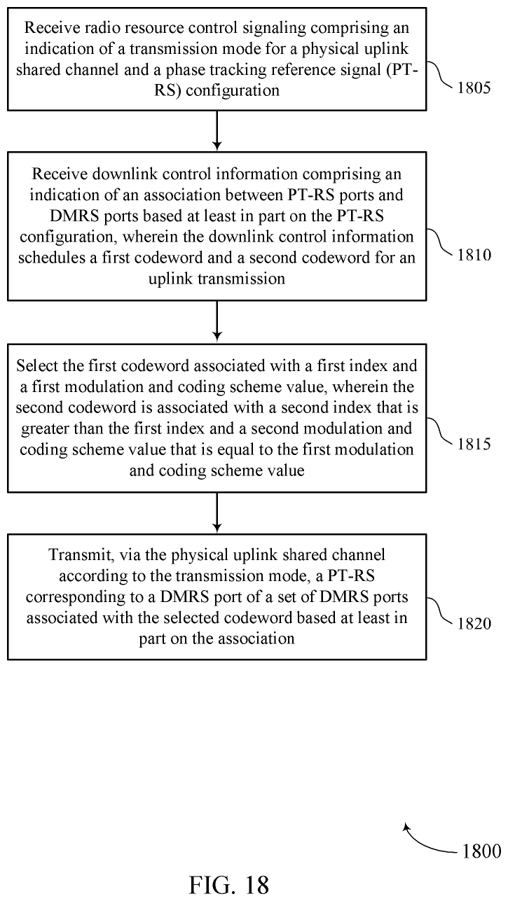

FIG. 18 shows a flowchart illustrating a method 1800 that supports reference signal association for multiple uplink codewords in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving radio resource control signaling including an indication of a transmission mode for a physical uplink shared channel and a phase tracking reference signal (PT-RS) configuration. The operations of 1805 may be performed in accordance with examples as disclosed herein. In some examples, aspects of the operations of 1805 may be performed by a control signaling component 925 as described with reference to FIG. 9.

At 1810, the method may include receiving downlink control information including an indication of an association between PT-RS ports and DM-RS ports based on the PT-RS configuration, where the downlink control information schedules a first codeword and a second codeword for an uplink transmission. The operations of 1810 may be performed in accordance with examples as disclosed herein. In some examples, aspects of the operations of 1810 may be performed by a reference signal association component 930 as described with reference to FIG. 9.

At 1815, the method may include selecting the first codeword associated with a first index and a first modulation and coding scheme value, where the second codeword is associated with a second index that is greater than the first index and a second modulation and coding scheme value that is equal to the first modulation and coding scheme value. The operations of 1815 may be performed in accordance with examples as disclosed herein. In some examples, aspects of the operations of 1815 may be performed by a codeword selection component 935 as described with reference to FIG. 9.

At 1820, the method may include transmitting, via the physical uplink shared channel according to the transmission mode, a PT-RS corresponding to a DM-RS port of a set of DM-RS ports associated with the selected codeword based on the association. The operations of 1820 may be performed in accordance with examples as disclosed herein. In some examples, aspects of the operations of 1820 may be performed by a reference signal component 940 as described with reference to FIG. 9.

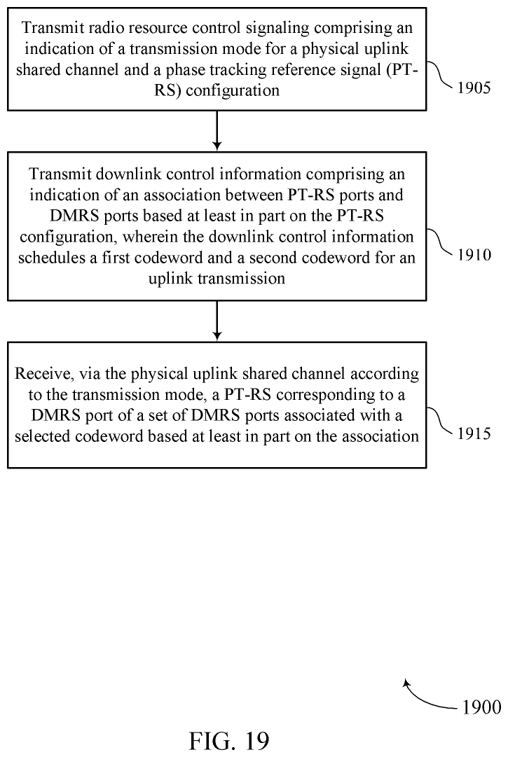

FIG. 19 shows a flowchart illustrating a method 1900 that supports reference signal association for multiple uplink codewords in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting radio resource control signaling including an indication of a transmission mode for a physical uplink shared channel and a phase tracking reference signal (PT-RS) configuration. The operations of 1905 may be performed in accordance with examples as disclosed herein. In some examples, aspects of the operations of 1905 may be performed by a control signaling component 1325 as described with reference to FIG. 13.

At 1910, the method may include transmitting downlink control information including an indication of an association between PT-RS ports and DM-RS ports based on the PT-RS configuration, where the downlink control information schedules a first codeword and a second codeword for an uplink transmission. The operations of 1910 may be performed in accordance with examples as disclosed herein. In some examples, aspects of the operations of 1910 may be performed by a reference signal association component 1330 as described with reference to FIG. 13.

At 1915, the method may include receiving, via the physical uplink shared channel according to the transmission mode, a PT-RS corresponding to a DM-RS port of a set of DM-RS ports associated with a selected codeword based on the association. The operations of 1915 may be performed in accordance with examples as disclosed herein. In some examples, aspects of the operations of 1915 may be performed by a reference signal manager 1335 as described with reference to FIG. 13.

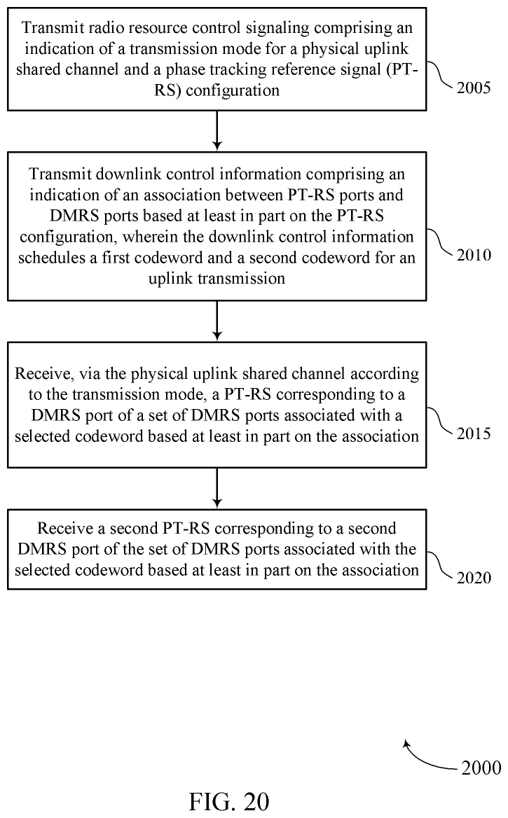

FIG. 20 shows a flowchart illustrating a method 2000 that supports reference signal association for multiple uplink codewords in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting radio resource control signaling including an indication of a transmission mode for a physical uplink shared channel and a phase tracking reference signal (PT-RS) configuration. The operations of 2005 may be performed in accordance with examples as disclosed herein. In some examples, aspects of the operations of 2005 may be performed by a control signaling component 1325 as described with reference to FIG. 13.

At 2010, the method may include transmitting downlink control information including an indication of an association between PT-RS ports and DM-RS ports based on the PT-RS configuration, where the downlink control information schedules a first codeword and a second codeword for an uplink transmission. The operations of 2010 may be performed in accordance with examples as disclosed herein. In some examples, aspects of the operations of 2010 may be performed by a reference signal association component 1330 as described with reference to FIG. 13.

At 2015, the method may include receiving, via the physical uplink shared channel according to the transmission mode, a PT-RS corresponding to a DM-RS port of a set of DM-RS ports associated with a selected codeword based on the association. The operations of 2015 may be performed in accordance with examples as disclosed herein. In some examples, aspects of the operations of 2015 may be performed by a reference signal manager 1335 as described with reference to FIG. 13.

At 2020, the method may include receiving a second PT-RS corresponding to a second DM-RS port of the set of DM-RS ports associated with the selected codeword based on the association. The operations of 2020 may be performed in accordance with examples as disclosed herein. In some examples, aspects of the operations of 2020 may be performed by a reference signal manager 1335 as described with reference to FIG. 13.

The following provides an overview of aspects of the present disclosure:

Aspect 1: A method for wireless communication at a UE, comprising: receiving radio resource control signaling comprising an indication of a transmission mode for a physical uplink shared channel and a phase tracking reference signal (PT-RS) configuration; receiving downlink control information comprising an indication of an association between PT-RS ports and demodulation reference signal (DM-RS) ports based at least in part on the PT-RS configuration, wherein the downlink control information schedules a first codeword and a second codeword for an uplink transmission; selecting a codeword from the first codeword and the second codeword for the uplink transmission; and transmitting, via the physical uplink shared channel according to the transmission mode, a PT-RS corresponding to a DM-RS port of a set of DM-RS ports associated with the selected codeword based at least in part on the association.

Aspect 2: The method of aspect 1, wherein selecting the codeword comprises: selecting the first codeword associated with a first modulation and coding scheme value, wherein the second codeword is associated with a second modulation and coding scheme value that is less than the first modulation and coding scheme value.

Aspect 3: The method of aspect 2, further comprising: determining that the first codeword associated with the first modulation and coding scheme value is associated with at least two SRS resource sets, at least two precoders, or both based at least in part on the PT-RS configuration indicating at least two available ports for transmitting one or more PT-RSs, wherein the physical uplink shared channel is associated with a first set of transmission parameters and a second set of transmission parameters.

Aspect 4: The method of aspect 3, further comprising: transmitting a second PT-RS corresponding to a second DM-RS port of a second set of DM-RS ports associated with the selected codeword based at least in part on the association.

Aspect 5: The method of any of aspect 1, wherein selecting the codeword comprises: selecting the first codeword based at least in part on the first codeword being associated with at least two SRS resource sets, at least two precoders, or both.

Aspect 6: The method of aspect 5, further comprising: determining that a second codeword is associated with at least two SRS resource sets, at least two precoders, or both, wherein selecting the first codeword is further based at least in part on a modulation and coding scheme value of the first codeword, an index of the first codeword, or both.

Aspect 7: The method of any of aspect 1, wherein selecting the codeword comprises: selecting the first codeword associated with a first index and a first modulation and coding scheme value, wherein the second codeword is associated with a second index that is greater than the first index and a second modulation and coding scheme value that is equal to the first modulation and coding scheme value.

Aspect 8: The method of any of aspect 1, wherein the radio resource control signaling, or the downlink control information, or both comprises an indication of the first codeword or the second codeword; and selecting the codeword comprises: selecting the indicated codeword.

Aspect 9: The method of any of aspects 1 through 8, wherein the PT-RS configuration indicates a single available port for transmitting a PT-RS and the transmission mode is codebook-based or non-codebook-based.

Aspect 10: The method of aspect 9, wherein the indication of the association comprises two bits indicating a DM-RS port of the set of DM-RS ports associated with the selected codeword.

Aspect 11: The method of any of aspects 1 through 10, wherein the PT-RS configuration indicates a plurality of available ports for transmitting one or more PT-RSs.

Aspect 12: The method of aspect 11, wherein the indication of the association comprises at least two bits, wherein a first bit indicates a DM-RS port of the set of DM-RS ports associated with the selected codeword and a second bit indicates a second DM-RS port of the second set of DM-RS ports associated with the selected codeword, the method further comprising: transmitting a second PT-RS corresponding to the second DM-RS port of the second set of DM-RS ports associated with the selected codeword based at least in part on the association.

Aspect 13: The method of aspect 12, wherein a rank of the physical uplink shared channel is less than or equal to a threshold rank.

Aspect 14: The method of any of aspects 12 through 13, wherein the set of DM-RS ports are associated with a first SRS resource set, a first precoder, or both and the second set of DM-RS ports are associated with a second SRS resource set, a second precoder, or both.

Aspect 15: The method of any of aspect 11, wherein the indication of the association comprises a plurality of bits, wherein a first subset of bits indicates a DM-RS port of the set of DM-RS ports associated with the selected codeword and a second subset of bits indicates a second DM-RS port of the set of DM-RS ports associated with the selected codeword, the method further comprising: transmitting a second PT-RS corresponding to the second DM-RS port of the second set of DM-RS ports associated with the selected codeword based at least in part on the association.

Aspect 16: The method of aspect 15, wherein a rank of the physical uplink shared channel is greater than a threshold rank.

Aspect 17: The method of any of aspect 11, wherein the set of DM-RS ports is associated with a first port for transmitting the PT-RS and a second set of ports is associated with a second port for transmitting a second PT-RS.

Aspect 18: The method of any of aspects 11 through 17, wherein the transmission mode is non-codebook-based.

Aspect 19: The method of aspect 18, wherein the downlink control information further comprises an SRS resource indicator that indicates a plurality of SRS resources, the method further comprising: determining which of the plurality of available ports to use for transmitting the one or more PT-RSs based at least in part on the selected codeword and the SRS resource indicator, wherein each SRS resource is associated with one of the plurality of available ports for transmitting one or more PT-RSs.

Aspect 20: The method of aspect 19, wherein determining which of the plurality of available ports to use for transmitting the one or more PT-RSs comprises: determining to use one of the plurality of available ports based at least in part on an PT-RS port index associated with each SRS resource of the SRS resources associated with the selected codeword being the same; or determining to use two or more of the plurality of available ports based at least in part on an PT-RS port index associated with multiple SRS resource associated with the selected codeword being different.

Aspect 21: The method of any of aspects 11 through 17, wherein the transmission mode is codebook-based.

Aspect 22: The method of aspect 21, wherein the downlink control information further comprises a transmit precoding matrix index, the method further comprising: determining which of the plurality of available ports to use for transmitting the one or more PT-RSs based at least in part on the selected codeword and the transmit precoding matrix index, wherein the transmit precoding matrix index indicates a set of antenna ports for transmitting the physical uplink shared channel and a precoding matrix comprising an association between the set of DM-RS ports and the set of antenna ports.

Aspect 23: The method of aspect 22, wherein determining which of the plurality of available ports to use for transmitting the one or more PT-RSs comprises: determining to use one or more of the plurality of available ports based at least in part on the association between the set of DM-RS ports and the set of antenna ports.

Aspect 24: The method of any of aspects 1 through 23, wherein the physical uplink shared channel is associated with a first set of transmission parameters and a second set of transmission parameters.

Aspect 25: A method for wireless communication, comprising: transmitting radio resource control signaling comprising an indication of a transmission mode for a physical uplink shared channel and a phase tracking reference signal (PT-RS) configuration; transmitting downlink control information comprising an indication of an association between PT-RS ports and demodulation reference signal (DM-RS) ports based at least in part on the PT-RS configuration, wherein the downlink control information schedules a first codeword and a second codeword for an uplink transmission; and receiving, via the physical uplink shared channel according to the transmission mode, a PT-RS corresponding to a DM-RS port of a set of DM-RS ports associated with a selected codeword based at least in part on the association.

Aspect 26: The method of aspect 25, further comprising: receiving a second PT-RS corresponding to a second DM-RS port of the set of DM-RS ports associated with the selected codeword based at least in part on the association.

Aspect 27: The method of any of aspects 25 through 26, wherein the indication of the association comprises at least two bits indicating the DM-RS port of the set of DM-RS ports associated with the selected codeword.

Aspect 28: An apparatus for wireless communication at a UE, comprising a processor; memory coupled with the processor; and instructions stored in the memory and executable by the processor to cause the apparatus to perform a method of any of aspects 1 through 24.

Aspect 29: An apparatus for wireless communication at a UE, comprising at least one means for performing a method of any of aspects 1 through 24.

Aspect 30: A non-transitory computer-readable medium storing code for wireless communication at a UE, the code comprising instructions executable by a processor to perform a method of any of aspects 1 through 24.

Aspect 31: An apparatus for wireless communication, comprising a processor; memory coupled with the processor; and instructions stored in the memory and executable by the processor to cause the apparatus to perform a method of any of aspects 25 through 27.

Aspect 32: An apparatus for wireless communication, comprising at least one means for performing a method of any of aspects 25 through 27.

Aspect 33: A non-transitory computer-readable medium storing code for wireless communication, the code comprising instructions executable by a processor to perform a method of any of aspects 25 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive radio resource control signaling comprising an indication of a transmission mode for a physical uplink shared channel and a phase tracking reference signal (PT-RS) configuration;
receive downlink control information comprising an indication of an association between PT-RS ports and demodulation reference signal (DM-RS) ports based at least in part on the PT-RS configuration, wherein the downlink control information schedules a first codeword and a second codeword for an uplink transmission;
select a codeword from the first codeword and the second codeword for the uplink transmission; and
transmit, via the physical uplink shared channel according to the transmission mode, a PT-RS corresponding to a DM-RS port of a set of DM-RS ports associated with the selected codeword based at least in part on the association.

2. The apparatus of claim 1, wherein the instructions to select the codeword are executable by the processor to cause the apparatus to:
select the first codeword associated with a first modulation and coding scheme value, wherein the second codeword is associated with a second modulation and coding scheme value that is less than the first modulation and coding scheme value.

3. The apparatus of claim 2, wherein the instructions are further executable by the processor to cause the apparatus to:
determine that the first codeword associated with the first modulation and coding scheme value is associated with at least two sounding reference signal (SRS) resource sets, at least two precoders, or both based at least in part on the PT-RS configuration indicating at least two available ports for transmitting one or more PT-RSs, wherein the physical uplink shared channel is associated with a first set of transmission parameters and a second set of transmission parameters.

4. The apparatus of claim 3, wherein the instructions are further executable by the processor to cause the apparatus to:
transmit a second PT-RS corresponding to a second DM-RS port of a second set of DM-RS ports associated with the selected codeword based at least in part on the association.

5. The apparatus of claim 1, wherein the instructions to select the codeword are executable by the processor to cause the apparatus to:
select the first codeword based at least in part on the first codeword being associated with at least two SRS resource sets, at least two precoders, or both.

6. The apparatus of claim 5, wherein the instructions are further executable by the processor to cause the apparatus to:
determine that a second codeword is associated with at least two SRS resource sets, at least two precoders, or both, wherein selecting the first codeword is further based at least in part on a modulation and coding scheme value of the first codeword, an index of the first codeword, or both.

7. The apparatus of claim 1, wherein the instructions to select the codeword are executable by the processor to cause the apparatus to:
select the first codeword associated with a first index and a first modulation and coding scheme value, wherein the second codeword is associated with a second index that is greater than the first index and a second modulation and coding scheme value that is equal to the first modulation and coding scheme value.

8. The apparatus of claim 1, wherein:
the radio resource control signaling, or the downlink control information, or both comprises an indication of the first codeword or the second codeword; and
selecting the codeword comprises:
selecting the indicated codeword.

9. The apparatus of claim 1, wherein the PT-RS configuration indicates a single available port for transmitting a PT-RS and the transmission mode is codebook-based or non-codebook-based.

10. The apparatus of claim 9, wherein the indication of the association comprises two bits indicating a DM-RS port of the set of DM-RS ports associated with the selected codeword.

11. The apparatus of claim 1, wherein the PT-RS configuration indicates a plurality of available ports for transmitting one or more PT-RSs.

12. The apparatus of claim 11, wherein the indication of the association comprises at least two bits, and the instructions are further executable by the processor to cause the apparatus to:
transmit a second PT-RS corresponding to the second DM-RS port of the second set of DM-RS ports associated with the selected codeword based at least in part on the association.

13. The apparatus of claim 12, wherein a rank of the physical uplink shared channel is less than or equal to a threshold rank.

14. The apparatus of claim 12, wherein the set of DM-RS ports are associated with a first SRS resource set, a first precoder, or both and the second set of DM-RS ports are associated with a second SRS resource set, a second precoder, or both.

15. The apparatus of claim 11, wherein the indication of the association comprises a plurality of bits, and the instructions are further executable by the processor to cause the apparatus to:
transmit a second PT-RS corresponding to the second DM-RS port of the second set of DM-RS ports associated with the selected codeword based at least in part on the association.

16. The apparatus of claim 15, wherein a rank of the physical uplink shared channel is greater than a threshold rank.

17. The apparatus of claim 11, wherein the set of DM-RS ports is associated with a first port for transmitting the PT-RS and a second set of ports is associated with a second port for transmitting a second PT-RS.

18. The apparatus of claim 11, wherein:
the transmission mode is non-codebook-based.

19. The apparatus of claim 18, wherein the downlink control information further comprises an SRS resource indicator that indicates a plurality of SRS resources, and the instructions are further executable by the processor to cause the apparatus to:
determine which of the plurality of available ports to use for transmitting the one or more PT-RSs based at least in part on the selected codeword and the SRS resource indicator, wherein each SRS resource is associated with one of the plurality of available ports for transmitting one or more PT-RSs.

20. The apparatus of claim 19, wherein the instructions to determine which of the plurality of available ports to use for transmitting the one or more PT-RSs are executable by the processor to cause the apparatus to:
determine to use one of the plurality of available ports based at least in part on an PT-RS port index associated with each SRS resource of the SRS resources associated with the selected codeword being the same; or
determine to use two or more of the plurality of available ports based at least in part on an PT-RS port index associated with multiple SRS resource associated with the selected codeword being different.

21. The apparatus of claim 11, wherein:
the transmission mode is codebook-based.

22. The apparatus of claim 21, wherein the downlink control information further comprises a transmit precoding matrix index, and the instructions are further executable by the processor to cause the apparatus to:
determine which of the plurality of available ports to use for transmitting the one or more PT-RSs based at least in part on the selected codeword and the transmit precoding matrix index, wherein the transmit precoding matrix index indicates a set of antenna ports for transmitting the physical uplink shared channel and a precoding matrix comprising an association between the set of DM-RS ports and the set of antenna ports.

23. The apparatus of claim 22, wherein the instructions to determine which of the plurality of available ports to use for transmitting the one or more PT-RSs are executable by the processor to cause the apparatus to:
determine to use one or more of the plurality of available ports based at least in part on the association between the set of DM-RS ports and the set of antenna ports.

24. The apparatus of claim 1, wherein the physical uplink shared channel is associated with a first set of transmission parameters and a second set of transmission parameters.

25. An apparatus for wireless communication, comprising:
a processor;
memory coupled with the processor; and
instructions stored in the memory and executable by the processor to cause the apparatus to:
transmit radio resource control signaling comprising an indication of a transmission mode for a physical uplink shared channel and a phase tracking reference signal (PT-RS) configuration;
transmit downlink control information comprising an indication of an association between PT-RS ports and demodulation reference signal (DM-RS) ports based at least in part on the PT-RS configuration, wherein the downlink control information schedules a first codeword and a second codeword for an uplink transmission; and
receive, via the physical uplink shared channel according to the transmission mode, a PT-RS corresponding to a DM-RS port of a set of DM-RS ports associated with a selected codeword based at least in part on the association.

26. The apparatus of claim 25, wherein the instructions are further executable by the processor to cause the apparatus to:
receive a second PT-RS corresponding to a second DM-RS port of the set of DM-RS ports associated with the selected codeword based at least in part on the association.

27. The apparatus of claim 25, wherein the indication of the association comprises at least two bits indicating the DM-RS port of the set of DM-RS ports associated with the selected codeword.

28. A method for wireless communication at a user equipment (UE), comprising:
receiving radio resource control signaling comprising an indication of a transmission mode for a physical uplink shared channel and a phase tracking reference signal (PT-RS) configuration;
receiving downlink control information comprising an indication of an association between PT-RS ports and demodulation reference signal (DM-RS) ports based at least in part on the PT-RS configuration, wherein the downlink control information schedules a first codeword and a second codeword for an uplink transmission;
selecting a codeword from the first codeword and the second codeword for the uplink transmission; and
transmitting, via the physical uplink shared channel according to the transmission mode, a PT-RS corresponding to a DM-RS port of a set of DM-RS ports associated with the selected codeword based at least in part on the association.

29. The method of claim 28, wherein selecting the codeword comprises:
selecting the first codeword associated with a first modulation and coding scheme value, wherein the second codeword is associated with a second modulation and coding scheme value that is less than the first modulation and coding scheme value.

30. A method for wireless communication, comprising:
transmitting radio resource control signaling comprising an indication of a transmission mode for a physical uplink shared channel and a phase tracking reference signal (PT-RS) configuration;
transmitting downlink control information comprising an indication of an association between PT-RS ports and demodulation reference signal (DM-RS) ports based at least in part on the PT-RS configuration, wherein the downlink control information schedules a first codeword and a second codeword for an uplink transmission; and
receiving, via the physical uplink shared channel according to the transmission mode, a PT-RS corresponding to a DM-RS port of a set of DM-RS ports associated with a selected codeword based at least in part on the association.
